(19) United States
(12) Patent Application Publication
(10) Pub. No.: US 2013/0168970 A1
(43) Pub. Date: Jul. 4, 2013

(54) POWER GENERATORS AND METHODS

(71) Applicant: Kurt Paul Grossman, Newport Beach, CA (US)

(72) Inventor: Kurt Paul Grossman, Newport Beach, CA (US)

(21) Appl. No.: 13/730,709

(22) Filed: Dec. 28, 2012

Related U.S. Application Data
(60) Provisional application No. 61/581,820, filed on Dec. 30, 2011.

(51) Int. Cl. H02K 57/00

(52) U.S. Cl. CPC H02K 57/003
USPC 290/1 A

(57) ABSTRACT

A power generator comprises a hull that defines an air space and a fluid column. A weighted container is allowed to fall within the air space during a power generating stroke. The container interacts with an apparatus so as to drive a generator during the power stroke. After the power stroke, the container is ejected from the hull into the fluid column. The container is made buoyant and thus floats upwardly during a buoyant stroke. The buoyant container is retrieved as it approaches the top of the hull and reintroduced into the hull for another power generating cycle.

### RELATED APPLICATION

This application claims priority to provisional application No. 61/581,820, filed Dec. 30, 2011, the entirety of which is hereby incorporated by reference.

### BACKGROUND

1. Field

The following disclosure is related to power generators, and certain embodiments are more particularly directed to power generators using renewable sources.

2. Description of the Related Art

Energy, particularly electric power, is essential for maintaining the comforts of life and achieving high levels of industrial productivity. Traditionally, power generation has involved the use of non-renewable sources such as coal, oil, and nuclear fuel. Generating power from such sources involves considerable expense in the acquisition of the source material and causes substantial damage to the environment in the form of pollution. Some power generators use renewable sources such as solar and wind energy, and thus have reduced environmental impact. However, the availability of wind and solar energy depends on the environment and can be unpredictable. Hydropower involves damming large bodies of water and running water through turbines to generate electricity. Although hydropower does not generate pollutants per se, it requires a unique geography in order to be effective, and creates radical changes to the environment.

### SUMMARY

Accordingly, there is a need for power generation systems and methods that can employ renewable resources, have relatively little effect on the environment, can be operated without relying upon unpredictable environmental conditions, and do not substantially alter the environment in which it is placed. Further, there is a need for power generation systems and methods that can be employed in many locations, including, for example, urban and rural settings, and commercial, industrial, and domestic settings.

Thus, in accordance with some embodiments of this disclosure, a power generator (e.g., an electrical generator) includes a hull having an entry area and an exit area and defining an air space. The entry area can be disposed above the exit area. The air space can be in fluid communication with ambient air surrounding the hull. Some embodiments also include a fluid column configured to substantially enclose a volume of water or other fluid (e.g., oil, alcohol, or otherwise). For example, ambient air can be in contact with one, two, three, four, five, six, or more sides, of the hull. Some embodiments further include a weighted container having an adjustable buoyancy and a potential energy. The weighted container can be configured to fall through the air space by force of gravity, the container thereby losing at least some of the potential energy. Additionally, some embodiments include an electric power generation system. The electric power generation system can be configured to engage the weighted container as the weighted container falls through the air space to convert at least some of the lost potential energy into electricity. The entry area can be configured to selectively allow the weighted container to enter the air space. The exit area can be configured to selectively eject the weighted container from the air space to the fluid column. In some embodiments, when the weighted container is in the fluid column, the buoyancy of the weighted container is adjusted so that the weighted container floats in the water.

In certain embodiments, the generator is connected to, related with, contained by, or otherwise associated with a water tower. The water can be configured to store water in an elevated reservoir and to distribute water under pressure from the reservoir to a surrounding community. The fluid column can communicate with the water tower reservoir.

In some embodiments, the buoyancy of the weighted container is adjusted based on the vertical distance between the weighted container and the entry area and/or the surface of the water in the fluid column. For example, the buoyancy can be increased as the weighted container moves toward the surface of the water in the fluid column. In other arrangements, the buoyancy of the weighted container is increased and then decreased as the weighted container moves toward the surface of the water in the fluid column. In accordance with some configurations, the buoyancy of the weighted container is about neutral (e.g., the same as the surrounding water) when the weighted container is approximately at the surface of the water (or approximately as near to the surface of the water as is generally traveled by the weighted containers) in the fluid column. In certain embodiments, when the weighted container floats in the water, the weighted container is configured to ascend along a majority of the vertical height of the fluid column.

In some embodiments, the entry area includes a gripper assembly. The gripper assembly can include, for example, a chamber and one or more grips. The chamber can be configured to receive the weighted container. The one or more grips can be configured to secure the weighted container in the gripper assembly. In certain embodiments, the electric power generation system includes a guard. The guard can have an actuator and define a space. In some variants, the gripper assembly is configured to rotate into alignment with the guard, thereby allowing the weighted container to be transferred from the gripper assembly to the guard by releasing the one or more grips.

In accordance with certain embodiments, the fluid column includes a substantially horizontal lower portion and a substantially horizontal upper portion connected by a substantially vertical portion. In some arrangements, the generator also has a second weighted container. One of the weighted container and the second weighted container can be configured to move through the lower portion and the other of the weighted container and the second weighted container can be configured to move through the upper portion. The weighted containers can be configured to concurrently move through the upper portion and the lower portion in substantially opposite directions.

In some embodiments, the generator has a vertical support system. The vertical support system can include a pulley and an elongate member. The pulley and/or the elongate member can be connected with the electric power generation system. In some arrangements, the vertical support system is configured to reduce the stress on the electric power generation system, such as when the weighted container nears the end of its fall through the air space. In some variants, the vertical support system further comprises a brake. The brake can be configured to engage when the weighted container nears the end of its fall through the air space.

In certain embodiments, the generator has a horizontal support system. Some variants of the horizontal support system include a curved rail and a follower. The follower can be configured to ride along the rail when the electric power generation system is engaged with the weighted container.

In some embodiments, the electric power generation system includes a lever arm connected with a flywheel. In certain arrangements, the electric power generation system has an elongate member wound around a pulley.

In accordance with certain embodiments, a method of generating electricity includes providing a hull, a fluid column, and a weighted container. In certain such cases, the hull defines an air space and the air space is in fluid communication with ambient air surrounding (e.g., substantially surrounding or completely surrounding) the hull. In some arrangements, the fluid column is configured to substantially enclose a volume of water. In some embodiments, the weighted container has an adjustable buoyancy and a potential energy. The weighted container can be configured to fall through the air space by force of gravity, the container thereby losing at least some of the potential energy. The method can also include moving the weighted container into the air space. Some embodiments of the method also include engaging an electric power generation system with the weighted container as the weighted container falls through the air space to convert at least some of the lost potential energy into electricity. Further, the method can include ejecting the weighted container from the air space to the fluid column. In certain embodiments, the method includes adjusting the buoyancy of the weighted container when the weighted container is in the fluid column such that the weighted container is buoyant in the water.

In some embodiments, the method includes opening a door to an entry chamber. The entry chamber can be adjacent the air space. The method can also include moving the weighted container into the entry chamber and closing the door. Further, the method can include removing substantially all of the water in the entry chamber.

In certain embodiments, the method also includes loading the weighted container into a chamber of a gripper assembly. Additionally, the method can include closing at least one grip on a gripper assembly. Some embodiments also include rotating the gripper assembly. The method can further include releasing the at least one grip. Also, the method can include transferring the weighted container to the electric power generator. For example, the transfer can occur by force of gravity.

In accordance with some embodiments, a power generator has a first container and a second container and a fluid column. The fluid column can include a substantially horizontal lower portion and a substantially horizontal upper portion connected by a substantially vertical portion. The fluid column can enclose a volume of a fluid having a density greater than air.

Some embodiments of the power generator also have a hull. The hull can include an entry portion and an exit portion with an air space therebetween. The entry portion can be configured to receive the first and second containers from the fluid column and to eject the first and second containers into the air space. The exit portion can be configured to receive the first and second containers from the air space and to eject the first and second containers into the fluid column. In accordance with some embodiments, the power generator can also have a generation system. The generation system can be configured to be located at least partly in the air space. The generation system can be configured to be energized by at least one of the first and second containers when at least one of the first and second containers are in the air space.

Furthermore, one of the first and second containers can be configured to move through the lower portion. The other of the first and second containers can be configured to move through the upper portion. The first and second containers can be configured to concurrently move through the upper portion and the lower portion in substantially opposite directions, thereby enhancing the balance of the generator.

In some embodiments, the fluid in the fluid column is water. In certain such cases, the water is salt water (e.g., seawater). In other such cases, the water is fresh water. In alternate embodiments, the fluid in the fluid column is oil, alcohol, or another liquid.

In certain embodiments, each of the first and second containers are configured to intake an amount of fluid before being ejected into the air space. Further, in certain such arrangements, each of the first and second containers are configured to expel at least some of the amount of fluid after being ejected into the fluid column.

In accordance with some embodiments, an electrical generator is provided, comprising a hull defining an air space and a water space. The water space has a water column, and an interface is defined between the air and water space. The air space is kept at a pressure sufficient so that water does not flow through the interface. A weighted container is configured to fall through the air space by force of gravity and enter the water space through the interface. An electric power generation system is configured to engage the weighted container as the weighted container falls through the air space so as to generate electric power.

Some such embodiments additionally comprise a plurality of valves configured to separate the water column into a plurality of columns that do not communicate head therebetween.

### BRIEF DESCRIPTION OF THE DRAWINGS

FIG. 1 illustrates a schematic representation of the operational theory of a power generator in accordance with an embodiment.

FIG. 2 illustrates a schematic representation of a power generator in accordance with an embodiment.

FIG. 2A illustrates the power generator of FIG. 2 on a trailer and ready for relocation.

FIG. 3 illustrates a perspective view of an embodiment of a weighted container configured to be employed with the power generator of FIG. 2.

FIG. 4 illustrates the power generator of FIG. 2 in an intermediate position of a gravity-driven power stroke.

FIG. 5 also illustrates the power generator of FIG. 2 nearing the end of a gravity-driven power stroke.

FIG. 6 illustrates a portion of the power generator of FIG. 2 in which the weighted container of FIG. 3 is progressing toward an exit area.

FIG. 7 illustrates the configuration of FIG. 6 with the weighted container entering an exit chute.

FIG. 8 illustrates the configuration of FIG. 6 with the weighted container progressing through the exit chute.

FIG. 9 illustrates the configuration of FIG. 6 with the weighted container exiting the exit chute.

FIG. 10 illustrates the configuration of FIG. 6 with the weighted container having exited the exit chute.

FIG. 11 illustrates a sectional view of the container of FIG. 3 along line 11-11.

FIG. 12 illustrates a schematic representation of the container of FIG. 3 in various states of ascent.

FIG. 13 illustrates a schematic sectional view of an embodiment of an entry area of the power generator of FIG. 2.

FIG. 14 illustrates an embodiment of a gripper assembly employed in an embodiment of a transfer mechanism of a power generator.

FIG. 15 illustrates a schematic representation of an embodiment of a transfer mechanism of a power generator, the transfer mechanism in a first state.

FIG. 16 illustrates a schematic representation of the transfer mechanism of FIG. 15 in a second state.

FIG. 17 illustrates a schematic representation of the transfer mechanism of FIG. 15 in a third state.

FIG. 18 illustrates a schematic representation of the transfer mechanism of FIG. 15 in a fourth state.

FIG. 19 illustrates a schematic representation of a container transfer process, which can be employed with various embodiments of the power generators.

FIG. 20 illustrates a schematic representation of another embodiment of a power generator, including a support assembly and winch assembly.

FIG. 21 illustrates a partial sectional view of the power generator of FIG. 20 along line 21-21.

FIG. 22 illustrates a schematic representation of another embodiment of a power generator, the power generator employed with a water tower.

FIG. 22A illustrates a partial cross-sectional view of an embodiment of a vertical portion of the power generator of FIG. 22, the vertical portion defining a sub-portion of a pipe.

FIG. 23 illustrates a schematic representation of another embodiment of a power generator.

FIG. 24 illustrates a schematic representation of another embodiment of a power generator.

FIG. 25 illustrates the power generator of FIG. 24 employed in an elevator shaft.

FIG. 26 illustrates a schematic representation of another embodiment of a power generator, the power generator employed with a vertical structure with an elevated tank.

FIGS. 27A-B illustrate a schematic view of an embodiment of a weighted container.

FIG. 28 illustrates a schematic representation of another embodiment of a power generator.

FIG. 29 illustrates a schematic representation of yet another embodiment of a power generator.

FIGS. 30A and B illustrate a schematic representation taken along line 30-30 of FIG. 29.

FIGS. 31A and B illustrate a schematic representation taken along line 31-31 of FIG. 29.

FIGS. 32A-C illustrate a release of a container taken along direction 32-32 of FIG. 31.

FIGS. 33 and 34 illustrate a schematic representation of yet another embodiment of a power generator.

FIG. 35 illustrates a schematic representation of a modular power generator.

### DETAILED DESCRIPTION

A variety of examples of power generation systems and methods are described below to illustrate various examples that may be employed to achieve the desired improvements. These example embodiments are only illustrative and not intended in any way to restrict the general inventions presented and the various aspects and features of these inventions. For example, although certain embodiments and examples are provided herein in connection with water towers and elevator shafts, the inventive aspects described herein are not confined or in any way limited or restricted to such uses. However, for example, inventive aspects discussed herein in connection with water towers may also be used in connection with elevator shafts and vice versa, and also with other structures. Furthermore, the phraseology and terminology used herein is for the purpose of description and should not be regarded as limiting. No features, structure, or step disclosed herein is essential or indispensable.

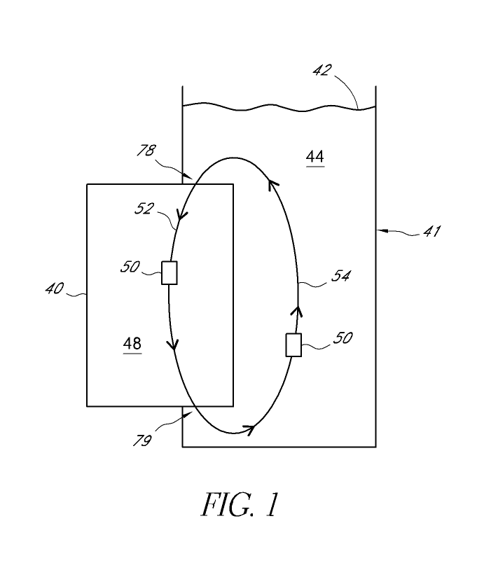

FIG. 1 is a schematic operational diagram demonstrating an operational theory in accordance with an embodiment of a power generating system. As shown, the power generating system can include a hull 40 and a fluid column 41. For example, the fluid column 41 can be a part of a water tower. The hull 40 defines an air space 48. The fluid column 41 defines a chamber 44 that is substantially filled with a fluid having a density greater than air, such as water (e.g., fresh water or salt water), alcohol, oil, or otherwise. Indeed, although certain examples in the present disclosure discuss the use of water, such discussion is illustrative only and is not intended to be limiting. Further, although the huyll air space 48 comprises air in the illustrated embodiment, other embodiments can use another fluid instead. Preferably, however, the fluid in the air space 48 is less dense than the fluid of the fluid column 41.

A container 50 having a mass, such as a vessel that may or may not hold a quantity of water, has gravitational potential energy, when positioned generally near the top of the air space 48, which is a first environment having a first fluid density. As used herein, the term “container” is a broad term having its ordinary meaning and can include, without limitation, any enclosure, reservoir, vessel, body, housing, or other structure having a mass and some degree of, or potential for, buoyancy. The container 50 is more dense than the surrounding air and thus is allowed to fall by virtue of gravity. In certain configurations, the container 50 is connected to a generator so that as the device loses gravitational potential energy at least a portion of that energy is converted into another form of energy, such as electricity. This action can be referred to as a gravity-driven power generation stroke 52, falling stroke, or power stroke. Once the power stroke 52 is completed, the container 50 is ejected (actively or passively) from the hull 40 into the chamber 44 of the fluid column 41, which is a second environment having a second fluid density.

In the chamber 44 of the fluid column 41, the container 50 is less dense than the surrounding fluid and thus exhibits a measure of buoyancy, floating upwardly, e.g., toward a surface 42 of the fluid. This action can be referred to as a buoyancy-driven return stroke 54, rising stroke, or buoyant stroke. Once the container 50 is at or near the top of the hull 40, it is retrieved and made to again enter the air space within the hull 40. Once within the hull, the container 50 again performs a power stroke 52, followed by a buoyant stroke 54, and the cycle continues. In some embodiments, power is generated as the massive container 50 falls during each power stroke, but minimal or no power is used as the container 50 rises during the buoyant stroke. Other embodiments may generate power on the buoyant stroke. Further details and examples of some embodiments of power generators and methods are provided in U.S. Patent Application Publication No. 2011/0012369, filed Jan. 19, 2010, titled “SUBMERGED POWER GENERATOR,” the entirety of which is incorporated herein by reference.

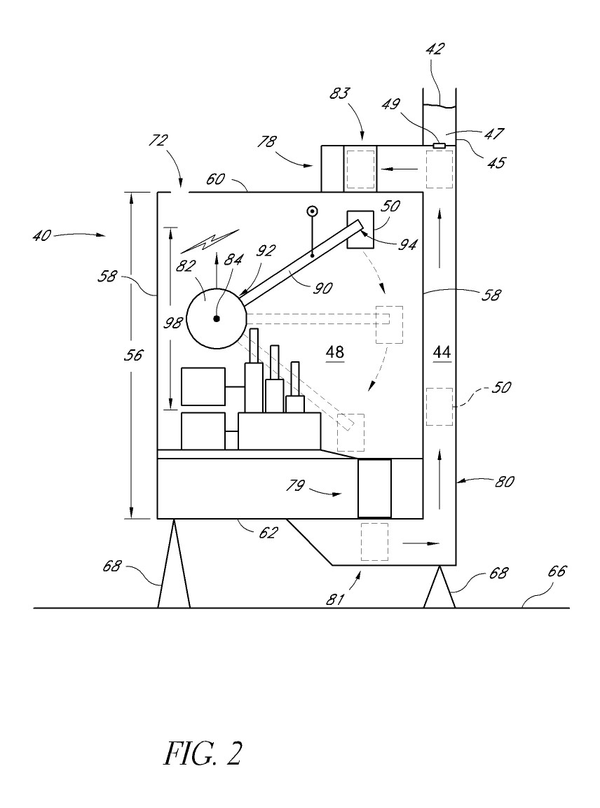

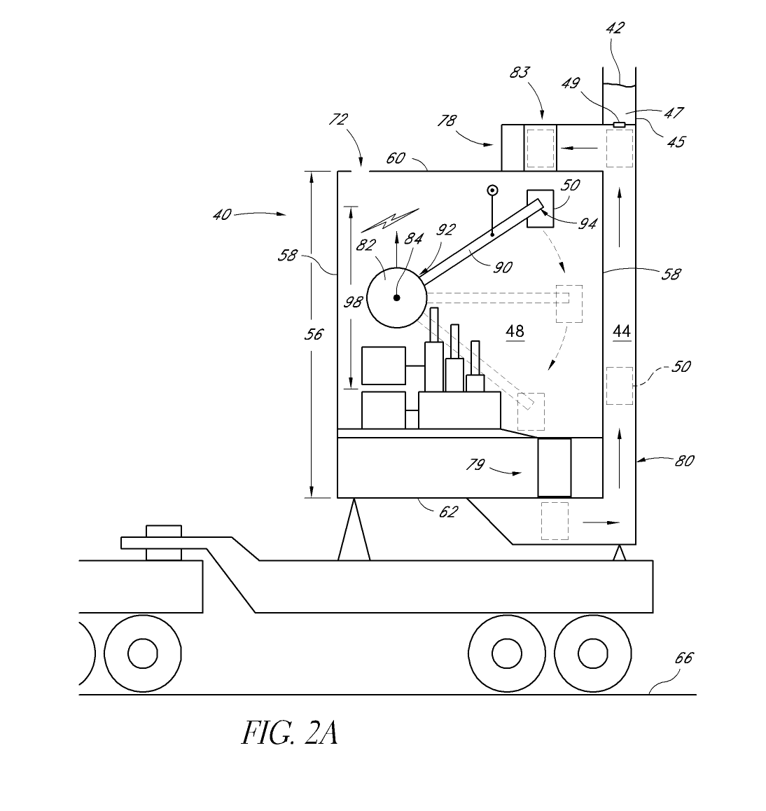

With reference next to FIG. 2, a schematic representation of an embodiment shows a hull 40 and a fluid column 41. The hull 40 is normally constructed to endure the rigors, pressures, and wear and tear of an industrial environment. For example, in some embodiments, the hull 40 is constructed of steel and is treated with anti-corrosive treatments such as marine paint. Other materials and treatments can be employed as appropriate. Generally, the hull 40 has a height or draft 56 that is substantially large, so as to take maximum advantage of the gravitational potential energy to be converted within the hull 40. For example, embodiments may employ hulls having a draft 56 of 20 yards, 50 yards, 100 yards, 200 yards, or more, as desired and as construction technology permits. In certain embodiments (such as those for use in vertical shafts, as will be discussed in greater detail below), the draft 56 can be about the height of such a shaft, e.g., 50 feet, 100 feet, 250 feet, 500 feet, 750 feet, 1,000 feet, 1,500 feet, or otherwise.

In the illustrated embodiment, a chamber 44 of the fluid column 41 is substantially or completely filled with water. In certain instances, the fluid column 41 includes a stack 45 that extends upward such that a surface 42 of the water can be located higher than the top of the hull 40. In some embodiments, the fluid column 41 includes a ventilation opening 47, which can allow ambient air to enter and exit the fluid column 41. Such configurations can, for example, maintain substantially ambient pressure in the chamber 44.

In certain embodiments, the ventilation opening 47 is covered with a filter 49, which can inhibit contaminants from entering the chamber 44. In some such embodiments, the filter is hydrophobic or otherwise configured to allow ambient air to pass into the chamber 44, but inhibit water or steam from passing from the chamber 44 to ambient air. Such a configuration can, for example, decrease the rate of evaporative water loss from the chamber 44. In other embodiments, the chamber 44 is closed, e.g., the fluid column 41 does not include the ventilation opening 47.

The illustrated hull 40 is generally rectangular in shape, having opposing vertical side walls 58 and top and bottom walls 60, 62. In some embodiments, the hull 40 is supported by legs 68. In some instances, the legs 68 are anchored in place. In some embodiments, portions of the hull 40 may define ballast tanks, which can be filled with water or the like to help maintain the hull 40 in a stable upright condition, e.g., inhibit tipping of the hull 40. It is to be understood that additional or alternative structures may be employed to secure the hull 40 in place.

In some embodiments, the hull 40 substantially encloses an air space 48 therewithin sot aht the air space is separated from the ambient environment. In other embodiments, the air space 48 is generally open to the ambient environment. For example, the hull 40 may include doors, windows, or other openings by which the air space 48 can communicate with the ambient air surrounding the hull 40. Thus, unlike some art, in certain embodiments, the hull 40 is not intended to provide a sealed space to allow the power generator to be submerged in a body of water (such as a lake or ocean). In some embodiments, the hull 40 includes a vent 72 that enables air to be ventilated into and out of the air space 48. The vent 72 can be configured to withstand environmental factors such as inclement weather, impacts, and the like without allowing substantial water incursion into the hull 40.

An entry area 78 at or near the top of the hull 40 can be configured so that a weighted container 50 in the chamber 44 can enter into the air space 48 within the hull 40. An exit area 79 is provided at or near the bottom of the hull 40 and is configured so that once the weighted container 50 has completed its power stroke, it proceeds to the exit area 79, which it is ejected into the chamber 44 of the fluid column 41.

In some embodiments, the fluid column 41 is disposed around at least part of the hull 40 and/or along the outside of the hull 40. As shown, in certain embodiments, the fluid column 41 includes a lower substantially horizontal portion 81 and an upper substantially horizontal portion 83 connected by a substantially vertical portion 80. The fluid column 41 is configured to contain and guide containers 50 upwardly through the vertical portion 80 generally toward the entry area 78. More particularly, the fluid column 41 defines a path the containers 50 may follow from the exit area 79, along the outside of the hull 40, and upwardly to the entry area 78. In some embodiments, the fluid column 41 is made of corrosion-resistant material, such as stainless steel. Other materials, such as anti-corrosion treated steels and the like, can also be employed.

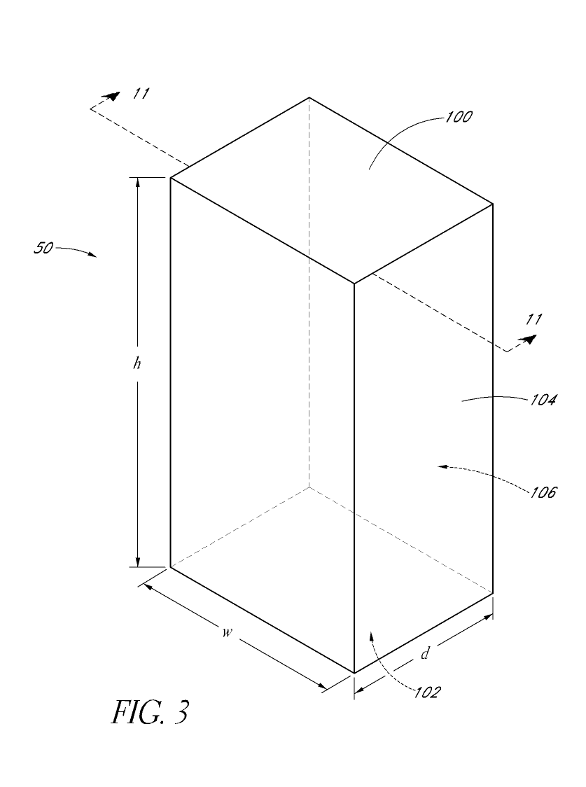

With continued reference to FIG. 2 and additional reference to FIGS. 3-5, an electric power generation system can be provided comprising a flywheel 82 and an axle 84 configured to be driven by a lever arm 90. A first end 92 of the lever arm 90 can be connected to the flywheel 82 so as to drive the flywheel 82. The weighted container 50 is releasably attached to a second end 94 of the lever arm 90 at a connection point. In certain such instances, the container 50 is configured to be substantially heavy, such as being filled with water. As shown, the weighted container 50 falls with gravity, a vertical power stroke distance 98 along a downward path, thus driving the flywheel 82. The flywheel 82 in turn is connected to an electric generator so that the power stroke of the container 50 falling along the path causes electricity to be generated. Such electricity can be communicated directly to wires that eventually join with a commercial electricity grid delivering electricity to consumers. In other embodiments, the electricity is provided solely to properties and structures associated with the power generator. In still other embodiments, all or some of the generated electricity is maintained in one or more electricity storage devices, such as batteries, until needed for use.

At or near the end of the power generation stroke, the container 50 is disconnected from the second end of the lever arm 90. In some embodiments, the lever arm 90 is biased upwardly. Thus, when the weighted container 50 is disconnected from the lever arm 90, the arm 90 automatically moves upwardly to return to the top of the hull 40 so as to connect to another weighted container 50, and perform another power stroke. The lever arm 90 can be biased by any desired structure, such as a spring, counterweight, electric, hydraulic, or pneumatic motor, or the like.

In the illustrated embodiment, the lever arm 90 stops and reverses its motion at about the end of the power stroke. In certain embodiments, during the period when the lever arm 90 is stopping and reversing, the lever arm 90 is disconnected from any direct driving connection with the flywheel 82 and/or generator, so that stopping of the lever arm 90 does not also stop rotation of the generator. The lever arm 90 can drive the flywheel 82 through a drive interface such as gearing, so that during substantially the entire power stroke 52, the lever arm 90 will drive the flywheel 82, even if the lever arm 90 is moving comparatively slowly. In some embodiments, the drive interface may include a transmission, such as a multiple gear-ratio transmission, in which optional gears for a given state may be selected and/or a continuously variable transmission that is configured to optimize a mechanical advantage for driving the flywheel 82 and/or generator.

In some embodiments, the lever arm 90 connects to a drive interface by way of a selectively-engageable hydraulic clutch or the like so that the lever arm 90 can be selectively engaged or disengaged from the drive interface. In such embodiments, the hydraulic clutch is disengaged as the lever arm 90 stops to release the container 50, while the lever arm 90 returns to its upper position, and while the lever arm 90 is being re-engaged during the next power stroke. In still other embodiments, rather than an upwardly-biased and returning lever arm 90, the flywheel 82 is driven by a drive wheel having lever arms that move circumferentially about an axle.

In some embodiments, the electricity generator is spaced apart from the flywheel 82. For example, the flywheel 82 may be configured to drive a driveshaft or the like that in turn rotates a generator spaced from the flywheel 82. Some power generator embodiments may employ several power generating stations, such as the lever arm 90 and flywheel 82 arrangement, discussed above and shown in FIG. 2. For example, the hull 40 may include a plurality of such stations disposed side-by-side and sharing a common driveshaft that drives a generator disposed at some point along the shaft. In some embodiments, the hull 40 may be divided into several compartments, with each compartment comprising a lever arm 90 and flywheel 82 as discussed herein. In some such instances, the compartments are sealed to prevent water intrusion between the compartments. A hull having multiple compartments may also be used in embodiments having other types of electricity generation equipment, such as embodiments using a linear electric power generator.

As certain embodiments of the power generator are a substantially contained system, such configurations can be readily movable. For example, as shown in FIG. 2A, certain embodiments of the power generator can be transported by a vehicle (e.g., in or on a trailer, truck bed, flatbed, container, or otherwise). Such configurations can, for example, allow the power generator to be relocated based on energy demand. For example, the power generator can be moved into, and provide electricity to, areas in which the conventional supply of electricity has been interrupted, such areas having recently experienced a natural disaster. Further, some embodiments include one or more reinforced connection points configured to allow the power generator to be lifted, e.g., by a helicopter.

In some embodiments, the power generator is configured to facilitate packing and transport of the power generator. For example, some embodiments can be readily disassembled. In some such cases, the lower horizontal portion 81, the upper horizontal portion 83, and/or the vertical portion 80 can be configured to be disconnected from the remainder of the power generator. Such configurations can, for example, facilitate transporting the power generator in pieces, rather than in the assembled state. In some arrangements, the power generator is configured to be at least partly collapsible. For example, the vertical portion 80 can be configured to collapse in a telescoping fashion, thereby reducing the volume occupied by the vertical portion 80 during transport. In some embodiments, the containers 50 are configured to be removable from the hull 40 and/or the fluid column 41.

With reference to FIG. 3, the weighted container 50 typically is constructed of a sturdy material such as structural steel, so as to be durable in spite of the container 50 being repeatedly immersed in water. Also, the weighted container 50 can be configured to have a relatively large mass, so as to maximize its potential gravitational energy as it falls during the power stroke. In some embodiments, the container 50 is configured to have sufficient weight during the power stroke such that the downward force exerted on the container 50 by gravity is greater than the hydraulic pressure of the water on the exit area 79 (e.g., at the interface at which the container 50 exits the hull 40 and enters the fluid column 41).

In certain embodiments, a top wall 100, a bottom wall 102, and/or a side wall 104 of the weighted container 50 cooperate to define an enclosed space 106. In some embodiments, the enclosed space 106 may selectively be fully or partially filled with water, as will be described in more detail below. The illustrated weighted container 50 has a generally rectangular cross-section having a height h, width w, and depth d, and the height is greater than the width and depth. However, other embodiments include different shapes, such as spherical, oblate spheroidal, or otherwise. In certain embodiments, the container 50 is shaped so as to reduce drag as the container 50 ascends in the chamber 44. For example, at least one end of the container 50 can be rounded or angled. In some embodiments, the container 50 is substantially torpedo-shaped. For example, the container 50 can have a substantially domed or conical nose portion (e.g., formed by the top wall 100) and a generally cylindrical body portion (e.g., formed by the side wall 104). Some embodiments of the container 50 also have a substantially domed or conical tail portion (e.g., formed by the bottom wall 102). In certain embodiments, the container 50 includes fins, wings, stabilizers, wheels, rollers, or other features to facilitate movement of the container 50 within the fluid column 41. For example, fins could be configured to encourage the container 50 to ascend the fluid column 41 in a generally straight line, thereby reducing the chance of the container 50 becoming cocked or askew within the fluid column 41, and wheels can aid the container in interacting with guide structures placed in the fluid column 41.

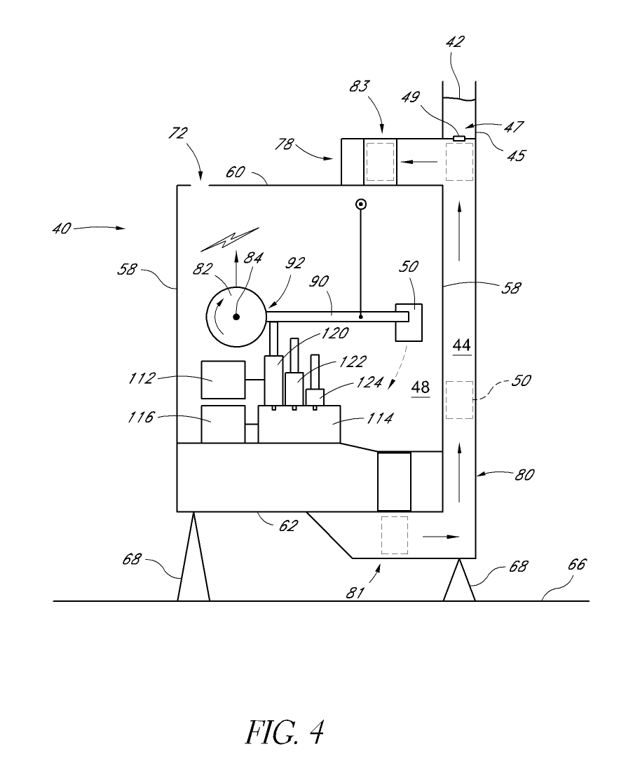

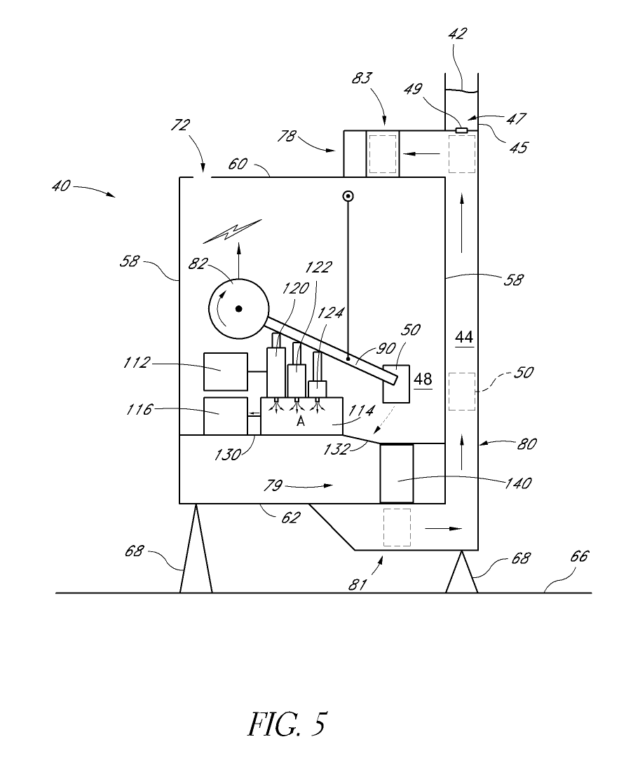

The embodiment illustrated in FIGS. 2-5 also comprises a pneumatic power generation system comprising a first or staging air tank 112, second or medial tank 114, and third or primary air tank 116. In some instances, a plurality of piston-type compressors 120, 122, 124 are configured to compress air into the medial air tank 114. With continued reference to FIGS. 2-5, during the power generation stroke, substantial downward momentum may be generated as the container 50 falls while connected to the lever arm 90. As shown specifically in FIGS. 4 and 5, at a point along the downward path of the power stroke, a portion of the lever arm 90 contacts a compressor arm of a first air compressor 120. As the container 50 continues to fall and the lever continues to rotate, the lever arm 90 engages second and third compressors 122, 124. This compressing action has the effect of both pressurizing air A in the medial air storage tank 114 and braking the lever arm 90 and the falling container 50. Thus, at least some of the kinetic energy and the gravitational potential energy of the container 50 is captured and stored as pressurized air as the container 50 falls, and the container 50 is slowed so as to stop at the correct and safe point at or near the bottom of the power stroke.

With continued reference to FIGS. 4 and 5, in some cases, pressurized air is desired to be maintained in the primary tank 116 within a range of pressures. Generally, such pressures exceed the pressure exerted by the water in the chamber 44 at or near the bottom 62 of the hull 40. The first or staging tank 112 can include air that is pressurized at a comparably low pressure, such as air obtained from the environment and/or scavenged from tooling or other sources as discussed below. The staging tank 112 provides air to the compressors which, as just discussed, further pressurize the air into the medial storage tank 114. When the pressure in the medial tank exceeds a designated threshold pressure, such as during the air pressurization portion of the power stroke, air flows into the primary storage tank 116. Thus air pressure between the tanks is regulated within a chosen range. In some embodiments, a motorized air compressor may additionally be employed as desired to maintain appropriate pressures.

In certain embodiments, valves are provided to maintain appropriate control over airflow between the tanks. In the illustrated embodiment, three compressors have been shown. This is a schematic illustration to demonstrate the use of multiple compressors, and it is to be understood that one or many compressors may be employed. Additionally, the compressors can be arranged in stages so that one or more of the compressors may compress air to a higher pressure than others of the compressors, which may, for example, pressurize a larger volume of air at a lower pressure. The staging and placement of the compressors can be chosen so as to generate a desired amount of compressed air, while simultaneously providing a desired amount of braking for the falling container 50. Typically, the threshold pressure and valve configuration is selected so that the falling container 50 is braked, in order to facilitate stopping the container 50 at an appropriate point.

In another embodiment, one or more air compressors may be configured to be selectively driven by the flywheel 82. As such, during at least a portion of the power stroke, rotation of the flywheel 82 pressurizes air. Embodiments are contemplated in which such radial compressors are provided instead of or in addition to the piston-type compressors discussed above. In some such embodiments, a hydraulic clutch or other selective engagement mechanism is configured such that the flywheel 82 and/or lever arm 90 engages a radial compressor during a portion of the power stroke, and the lever arm 90 successively engages a plurality of radial-type air compressors during the power stroke so as to apply braking as desired. Still further, in some embodiments, air compression may be preferred over electricity generation, and one or more air compressors may be provided instead of an electricity generator.

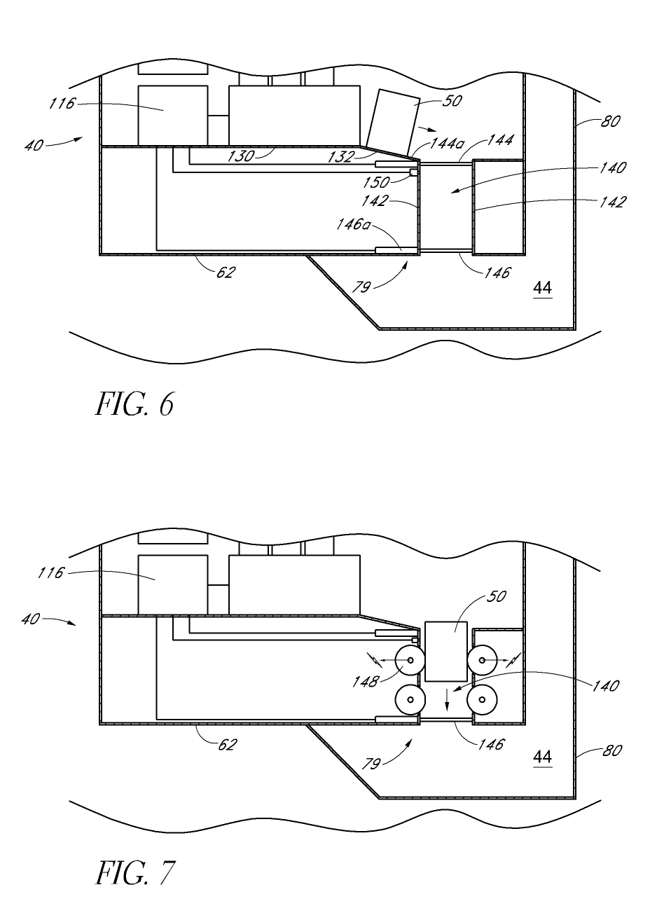

With particular reference next to FIG. 6, once the container 50 has completed its power stroke, it is disconnected from the lever arm 90 and released to the floor 130 of the hull 40. As shown, the floor 130 can have an inclined portion 132 upon which the container 50 slides or rolls toward an exit chute 140 of the exit area 79. In some arrangements, the exit chute 140 is elongate and defined by walls 142 that extend from the floor 130 to the bottom 62 of the hull 40. The illustrated chute 140 has an inner hatch 144 and an outer hatch 146, both of which can be pneumatically operated by corresponding pneumatic actuators 144a, 146a using pressurized air sourced from the primary tank 116. Thus, pressurized air generated during the power stroke is utilized during other stages of operation. In other embodiments, the hatches 144, 146 may be operated by other structure and methods such as solenoids or the like. Also, in other embodiments, pressurized air or electricity can be used to apply pressure to a hydraulic system which in turn operates aspects such as hatches and the like. In certain embodiments, the hatches are sliding, single-panel doors. In some instances, the hatches include low-friction material, such as polytetrafluoroethylene (PTFE). Other hatch configurations, such as multi-panel and/or swinging doors, can be used as desired.

When the container 50 is near or over the inner hatch 144, the inner hatch 144 is opened, allowing the weighted container 50 to fall into the exit chute 140. Some embodiments, such as the embodiment shown in FIG. 7, include another electricity generation and braking system disposed in the exit chute 140, comprising wheels 148 that both control the weighted container's descent and drive a generator so that electricity is generated in the process, such as in a manner similar to automotive regenerative braking.

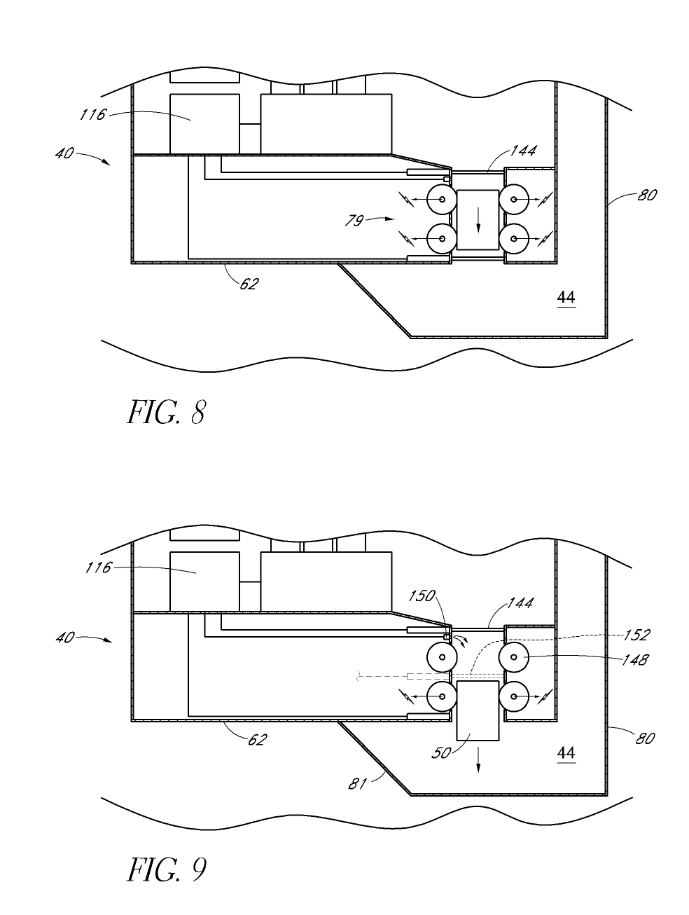

As shown next in FIG. 8, preferably the inner and outer hatches 144, 146 are both closed for at least some period of time when the container 50 is fully within the exit chute 140. Also, typically the size tolerances between the exit chute walls 142 and the container 50 are particularly close, so that there is little space between the exit chute walls 142 and the container 50. In some embodiments, the exit chute walls 142 and/or the walls of the container 50 are configured to promote sliding and reduce friction. For example, the exit chute walls 142 and/or the walls of the container 50 can have a PTFE coating.

As shown in FIG. 9, after the inner hatch 144 has been closed with the container 50 in the chute 140, the outer hatch 146 may then be opened and the container 50 (due to its weight) can continue to fall out of the chute 140 and into the chamber 44. In some instances, a pressurized air source 150 delivers pressurized air into the chute 140 above the container 50, so as to relieve any resistance due to vacuum and to urge the container 50 through the outer hatch 146. In certain embodiments, the air is pressurized in a range that approximates or exceeds the pressure of the water at the depth of the outer hatch 146. Thus, the container 50 is readily ejected while inhibiting or preventing water entry into the exit chute 140 and hull 40.

In some embodiments, and as shown schematically in phantom in FIG. 9, one or more additional hatches 152 may be provided so that when the container 50 passes a particular point, the hatch 152 at that point can be closed so as to further reduce both the likelihood of water incursion and the amount of, or need for, pressurized air to prevent such incursion. In some embodiments, the hatch 152 is positioned closer to the outer hatch 146 than to the inner hatch 144. In certain implementations in which the container 50 has a dome-shaped end, the distance between the hatch 152 and the outer hatch 146 is about the height of the dome. After the container 50 clears the outer hatch 146, the hatch 146 is closed and the container 50 continues to sink. Pressurized air within the exit chute 140 can then be returned to one of the tanks, such as the medial tank 114 or staging tank 112 for repressurization, or can be pumped back to the primary tank 116.

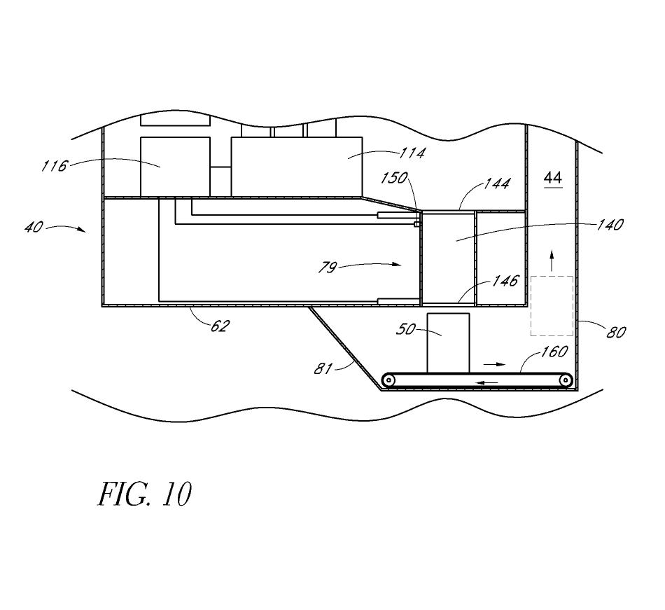

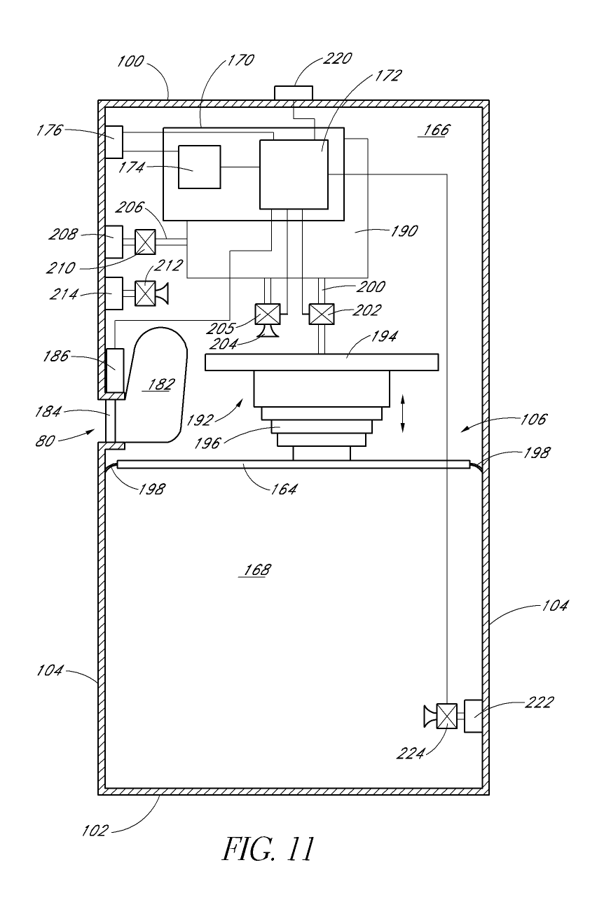

Once clear of the hull 40, the container 50 is fully within the chamber 44, as illustrated in FIG. 10. As shown, the outer hatch 146 of the exit chute 140 can open within the lower horizontal portion 81 of the fluid column 41, so that the container 50 is within the confines of the fluid column 41. The container 50 preferably sinks until it contacts the bottom of the lower horizontal portion 81. In the illustrated embodiment, a conveyor 160 is provided for moving the container 50 away from the exit chute 140 and toward the side of the hull 40 and/or the vertical portion 80 of the fluid column 41. It is to be understood that other apparatus can be employed to move the container 50 away from the exit chute 140. For example, hydraulically or pneumatically operated robotic or remote control arms, submarines, other submersible devices or the like can be employed. In some embodiments, the lower horizontal portion 81 is inclined, so that as the sinking container 50 contacts the lower horizontal portion 81, the container 50 is deflected or otherwise urged toward the side of the hull 40 and/or the vertical portion 80 of the fluid column 41 and away from the exit chute 140.

With reference next to FIG. 11, an embodiment of a variably-weighted container 50 is schematically shown in section so that interior structure is visible. The illustrated container 50 can selectively change its weight and increase or decrease its buoyancy. Generally, the sides and top and bottom walls are relatively thick and sturdy. A divider plate 164 can divide the space 106 within the container 50 into an upper space 166 and a lower space 168. In some embodiments, the container 50 includes an electronic unit 170, which in turn includes a processor or controller 172 and a power source such as a battery 174. An interface 176 can be disposed on a side wall of the container 50 to enable outside access for charging of the battery 174 and/or programming of the controller 172 when appropriate.

A mounting portion 180 can be provided along a wall of the container 50. In the illustrated embodiment, the mounting portion 180 is along a side wall 104 of the container 50 and comprises an inlet 182 adapted to accommodate a pin or the like on the second end of the lever arm 90 so as to rotatably connect the container 50 to the lever arm 90. In certain embodiments, a latch 184 opens to allow the lever arm pin to extend into the inlet 182 and closes to ensure a secure connection during the power stroke. In the illustrated embodiment, the latch 184 is actuated by a solenoid 186, which in turn is electronically controlled by the controller 172.

With continued reference to FIG. 11, a pressure vessel 190, more precisely a pressurized air tank, can be enclosed within the upper space 166. Additionally, a pneumatic actuator 192 comprises of a mount 194 and a pneumatically operated ram 196 attached to the divider plate 164. The divider plate 164 has seals 198 on opposing sides. The seals 198 engage the container side walls 104, so as to seal the lower space 168 from the upper space 166. An air line 200 extends from the air tank 190 to the pneumatic actuator 192, and the air supply is controlled through a valve 202 which is electronically controlled by the controller 172, so as to control the actuator 192.

An opening 204 from the air tank 190 into the upper air space 166 is also provided, and can include a valve 205 electronically controlled by the controller 172. An air fill line 206 and interface 208 extend to the side wall of the container 50 so that the air tank 190 can be selectively filled from a source outside the container 50. A valve 210, such as a one way valve, is provided to prevent leakage. Further, a pressure release valve 212 and interface 214 is also provided through the side wall 104 of the container 50, so as to selectively allow air to be evacuated from the upper space 166 when desired.

In certain embodiments, the container 50 includes a pressure sensor 220. The pressure sensor 220 can be configured to sense the pressure outside of the container 50 and to electronically communicate data concerning such pressure to the controller 172, which evaluates such data and controls various valves and the like in accordance with such data. In certain embodiments, the processor 172 is configured to determine an approximate depth (e.g., below the surface 42 of the water) of the container 50 based on data from the pressure sensor 220. As shown, the lower space 168 can have at least one water vent 222 that is selectively closed by a valve 224, which in turn is controlled by the controller 172.

As discussed above, in some configurations, the weighted container 50 is particularly heavy. For example, the weighted container 50 can be filled with water. In the illustrated embodiment, the water fills the lower space 168 of the container 50. Of course, as the drawing in FIG. 11 is schematic, in other embodiments, the upper and lower spaces 166, 168 may have different relative dimensions than as illustrated.

In operation, the lower space 168 can be approximately completely filled with water, which can enter through the water vent 222. Thus, water, in addition to the durable steel construction, can contribute substantial weight to the container 50 for the power stroke. As discussed above, typically the container 50 is weighted enough so that it falls out of the exit chute 140 into the water in the chamber 44. The controller 172 can be configured to recognize when the container 50 has exited from the hull 40 (e.g., by sensing that the water pressure is above a threshold value), and then to actuate the pneumatic ram 196 in order to expel at least some of the water out of the lower space 168 and into the surrounding environment (e.g., the fluid column 41). In some embodiments, air from the tank 190 is vented into the upper space 166, through the opening 204, so as to increase the buoyancy of the container 50. Eventually, the overall density of the container 50 decreases so that it has sufficient buoyancy to begin floating upwardly in the water in the chamber 44. Preferably, by this time, the container 50 will have been transferred to the side of the hull 40 and/or to the vertical portion 80 of the fluid column 41, thereby allowing the container 50 to float upwardly toward the top of the hull 40 as shown in FIGS. 2 and 10.

As the container 50 floats upwardly, the sensor 220 detects the change in surrounding water pressure, and in response the controller 172 adjusts operation of the ram 196. For example, the controller 172 can halt operation of the ram 196 so as to not further increase buoyancy. As such, the now-buoyant container 50 floats upwardly toward the top of the hull 40 at a controlled pace. In some embodiments, as the container 50 moves upwardly, the pneumatic ram 196 may be retracted in order to further control, and in some cases slow, the ascent of the container 50.

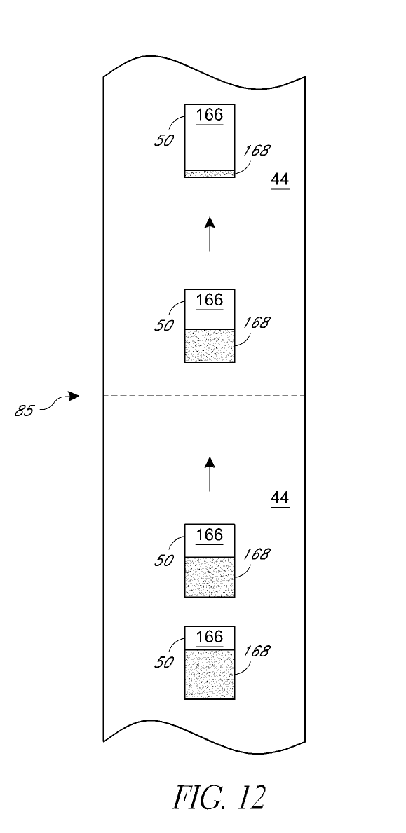

Generally, the force required to expel a given amount of water from the container 50 decreases as the depth of the container 50 below the surface 42 of the water decreases. Accordingly, in some embodiments, the container 50 is configured to vary the amount of water expelled based on the depth of the container 50. For example, as shown in FIG. 12, the container 50 can be configured to expel a relatively small amount of water (and retain a relatively large amount of water in the lower space 168) when the container 50 is at a greater depth, and to expel a larger amount of water (and retain only a small amount of water in the lower space 168) when the container 50 is at a shallower depth. Such a configuration can, for example, reduce the amount of energy used to expel the water from the container 50 by timing the expulsion of the larger portion to occur at a reduced water pressure. In certain embodiments, as the container 50 is ascending, the container expels an amount of water that is proportional to the depth of the container.

In certain embodiments, the container 50 is configured to begin and end its ascent in the vertical portion 80 in a controlled manner. For example, the container 50 can be configured such that, when the container 50 is at the bottom of the vertical portion 80, the container 50 expels an amount of water sufficient to render the container 50 slightly more buoyant than the surrounding water, which results in the container 50 floating slowly upward. In some arrangements, the rate of ascent of the container 50 is substantially constant. However, in other instances, the rate of ascent of the container 50 increases up to a reflection line 85 on the vertical portion 80. In certain instances, the reflection line 85 is located at about the midpoint of the vertical portion 80. In other instances, the reflection line 85 is located between about the midpoint of the vertical portion 80 and the top of the vertical portion 80.

In some arrangements, when the container 50 is at or has passed the reflection line 85, the ascent rate of the container 50 is reduced. For example, the rate of ascent of the container 50 can be reduced by the container 50 taking in an amount of water to make the container 50 less buoyant. In some embodiments, the container 50 is configured to intake a sufficient amount of water such that, when the container 50 is about at the top of the vertical portion 80, the container 50 has about neutral buoyancy (e.g., is about as buoyant as the surrounding water). Such a configuration can, or example, inhibit the container 50 from crashing into or otherwise damaging the top of the vertical portion 80 of the fluid column 41.

In alternate embodiments, the container 50 is substantially constantly-weighted. For example, some embodiments of the container 50 have about the same weight during the power stroke and during ascent in the fluid column 41. In some embodiments, as the container 50 moves through the lower horizontal portion 81 it has about the same weight as when it moves through the upper horizontal portion 83.

In some embodiments, the substantially constant weight is achieved by the container 50 enclosing a generally constant volume and/or mass of fluid. For example, the enclosed space 106 of the container 50 can enclose a substantially unchanging volume and/or mass of water, air, gel, or otherwise. In certain implementations, the fluid in the container 50 is the same as the fluid in the fluid column 41 (though additional fluids, such as air, may be included as well). In other implementations, the fluid in the container 50 is different than the fluid in the fluid column 41. For example, in some embodiments, the fluid in the fluid column 41 is salt water and the fluid in the container 50 is fresh water or a combination of fresh water and air.

In some embodiments, the container 50 is not configured to vary the amount of fluid within the container 50. Accordingly, some such embodiments of the container 50 do not include certain features for varying the amount of fluid within the container 50. For example, in certain instances, the container 50 does not include the divider plate 164 and/or the actuator 192. Some embodiments of the container 50 do not include the vent 222 and the valve 224. In certain implementations, the enclosed space 106 not divided into the upper space 166 and the lower space 168. Such configurations can, for example, reduce the total number of components of the container 50, facilitate manufacturability, reduce cost, and/or increase reliability.

In some implementations, the container 50 is configured to be always slightly or minimally positively buoyant in the fluid of the fluid column 41. Such instances of the container 50 can thus ascend in the vertical portion 80 of the fluid column 41 without expelling fluid from the enclosed space 106. Such a configuration can, for example, reduce the amount of energy used for producing and storing pressurized air, transferring pressurized air to the container 50, and/or expelling fluid from the lower space 168 (e.g., operating the actuator 192 and valve 224). Furthermore, employing only slight or minimal buoyancy (compared to, for example, a large amount of buoyancy) can facilitate a controlled rate of ascent of the container 50, thereby reducing the likelihood of the container 50 crashing into the top of the hull 40. Moreover, such configurations can increase and/or maximize the weight of the container 50, thereby enhancing power generation as the container 50 falls during of the power stroke.

In certain embodiments, the container 50 is slightly or minimally buoyant and slides out of the exit chute 140 by force of gravity. In other embodiments, the container 50 is slightly or minimally buoyant and is propelled or otherwise forced out of the exit chute 140. For example, the container 50 can be moved out of the exit chute 140 by pressurized air from the source 150. In some instances, the container 50 is moved out of the exit chute 140 by or by the wheels 148, which can be electrically or pneumatically powered (e.g., by the primary tank 116 or other components of the power generator). In some embodiments the container may be allowed to fall through the exit chute 140, and momentum from the fall assists the container in exiting through the chute 140.

Generally, after the container 50 has been ejected from the exit chute 140, the container 50 will temporarily continue to move away from the exit chute 140 due to the momentum of the container 50. However, in some cases, due to friction and other forces, the container 50 will generally slow and then begin to float back toward the exit chute 140. Thus, in certain arrangements, after the container 50 has been ejected from the exit chute 140, the outer hatch 146 is closed to inhibit or prevent the container 50 from floating partially back into the exit chute 140. As discussed above, the container 50 can be floated or be moved through the lower horizontal portion 81 of the fluid column 41 toward the vertical portion 80, where the container 50 can be allowed to ascend toward the top of the hull 40.

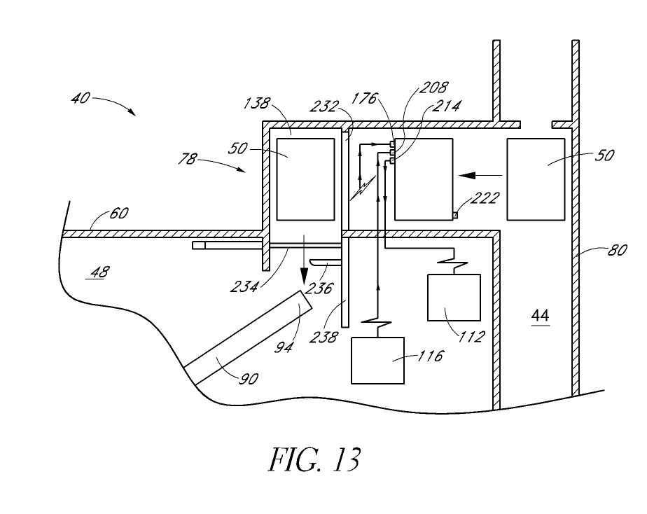

With reference to FIG. 13, once the container 50 has reached the top of the vertical portion 80, it is directed into the entry area 78, in which the container 50 is prepared for another power stroke, and again drawn into the hull air space 48. As shown, the container 50 can be directed over the top of the hull 40, such as by a mechanical apparatus like an arm, crane, or the like. The container 50 may then interface as appropriate with the apparatus so as to prepare it for another power stroke. For example, the electronic unit 170 interface 176 can be engaged with a source of electricity to charge the battery 174 and/or a master control system of the container 50, which can update control routines and exchange data with the controller 172. Also, the air pressure tank 190 can be recharged by connecting its interface 208 with, for example, the primary tank 116 of the hull 40. Additionally, through interface 214, air within the container upper space 166 may be vented from the container 50 and/or may be directed to a scavenging tank, such as the staging tank 112, for re-pressurization, thus facilitating full retraction of the pneumatic ram 196 and refilling of the lower space 168 with water through the at least one water vent 222.

In the illustrated embodiment, each of the interfaces connects independently with a respective resetting apparatus. In other embodiments, the interfaces may be combined into a single interface structure which may be engaged with the container interfaces manually and/or automatically, such as by robot and the like.

In preparation for reentry into the hull 40, the container 50 is advanced to an entry chamber 138. For example, the container 50 can proceed through a sealed entry door 232 to enter the entry chamber 138. In certain embodiments, the entry door 232 is automatically operated such as by a pneumatic or hydraulic actuator, and creates a seal when closed. Thus, when the entry door 232 is closed, the container 50 is separated from the chamber 44. In the entry chamber 138, further preparation can be performed, such as removal of water around the container 50 and, in some embodiments, substantially drying the container 50. Such operations may advantageously be powered by pneumatic, hydraulic and/or electric tools.

When the container 50 is ready and the lever arm 90 is returned to its upper position, an entry hatch 234 is opened and the container 50 proceeds downwardly. In some embodiments, the container 50 is supported by a support arm 236 that moves along a track 238 that controlledly guides the container 50 to a position at which it is latched securely onto the second end 94 of the lever arm 90. After the container 50 is securely latched to the lever arm 90, the power stroke begins.

The embodiments described above in connection with FIGS. 2-13 have followed a container through an operation cycle of the power stroke, exit, buoyancy stroke, and entry. In certain arrangements, the power generator includes several containers 50 participating in the operation cycle simultaneously. For example, one first container 50 may be performing a power stroke, another container 50 may be within the lower horizontal portion 81 and moving toward the side of the hull 40, yet another container 50 may be advancing upwardly through the vertical portion 80, still another container 50 may be moving through the upper horizontal portion 83, and a further container 50 may be undergoing final preparation before another power stroke. For increased efficiency, some embodiments employ a sufficient number of containers 50 such that a container 50 is always ready for a power stroke when the lever arm 90 returns to its upper position.

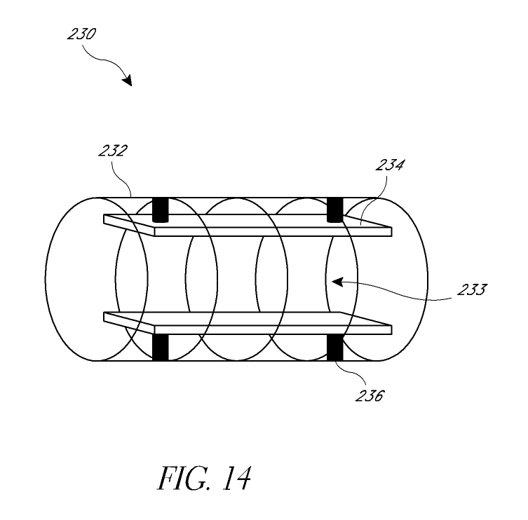

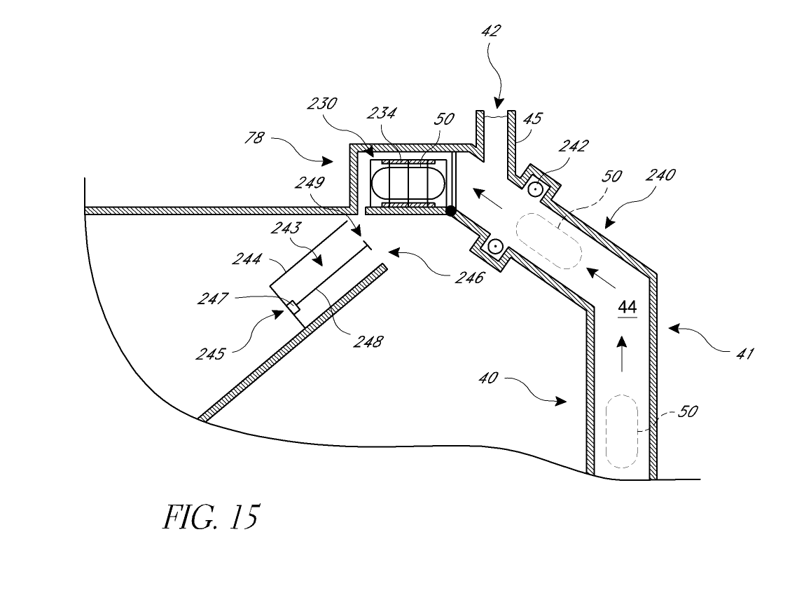

With regard to FIGS. 14-18, a portion of another embodiment of a power generator is illustrated. The power generator of FIGS. 14-18 is generally the same as the power generator embodiment of FIGS. 2-12 but with certain differences, some of which are discussed below. In particular, FIGS. 14-18 schematically illustrate the transfer of the container 50 between a gripper assembly 230 and the lever arm 90.

With regard to FIG. 14, in certain embodiments, the gripper assembly 230 is configured to receive the container 50. As shown, the gripper assembly 230 can include a body 232 and one or more grips 234. The body 232 is generally sized and shaped to receive the container 50. For example, as shown in FIG. 14, the body 232 can be substantially cage-like and includes a cavity 233 sized and shaped so as to be able to receive the container 50. The body 232 generally has sufficient structural strength to support the container 50 during transfer of the container 50 to the lever arm 90, as will be discussed in further detail below. Also, as certain embodiments of the gripper assembly 230 will be exposed to water during operation of the power generator, the body 232 and/or grips 234 are preferably corrosion-resistant, e.g., constructed of stainless steel components and/or painted with marine paint.

The grips 234 can be configured to pinch, wedge, grasp, hold, stabilize, or otherwise secure the container 50, when the container 50 is received in the body 234. In some embodiments, the grips 234 are moved by one or more actuators 236 (e.g., electric, pneumatic, or the like) that are operatively connected with, for example, the electrical power generated by the flywheel 82 and/or one of the air tanks 112, 114, 116. For example, in certain embodiments, the grips 234 are configured to move between a first state and a second state. In the first state, the grips are opened, thereby allowing the container 50 to be slidingly received in the cavity 233 of the body 232. In the second state, the grips 234 are closed, so as to pinch, wedge, grasp, hold, stabilize, or otherwise secure the container 50 in the cavity 233. In such arrangements, when the grips 234 are closed, relative movement between the container 50 and the gripper assembly 230 is prevented or inhibited. In some embodiments, the grips 234 have a rubberized or otherwise pliant surface that contacts the container 50, thereby reducing the likelihood of damage to the container 50 when the grippers 234 are closed on the container 50. Further, such a configuration can increase the friction between the grippers 234 and the container 50, thus reducing the chance of the container 50 unintentionally slipping out of the gripper assembly 230.

Generally, the gripper assembly 230 is configured to transfer the container 50 between the entry chamber 138 and the lever arm 90. For example, the gripper assembly 230 can be hingedly connected with the hull 40, thereby allowing the gripper assembly 230 to rotate downwardly toward the lever arm 90. Movement of the gripper assembly 230 can be automated and controlled, such as by electric or pneumatic motors or actuators, thereby inhibiting or preventing unintentional movement of the container 50. Such a configuration can, for example, reduce the likelihood of an error during transfer of the container 50 between the gripper assembly 230 and the lever arm 90, which could lead to damage to the container 50, lever arm 90, and gripper assembly 230, or other parts of the power generator.

As shown in FIG. 15, in certain embodiments, the fluid column 41 can include an angled or curved portion 240 between the vertical portion 80 and the entry area 78. In certain embodiments, the angled or curved portion 240 connects with the stack 45. As shown, the stack 45 can extend vertically beyond the top of the entry area 78, thereby allowing sufficient water to be maintained in the chamber 44 such that the surface 42 of the water is higher than the top of the entry area 78.

When the container 50 ascends through the vertical portion 80 and reaches the angled or curved portion 240, the buoyancy of the container 50 urges the container 50 through the angled or curved portion 240 and toward the entry area 78. Thus, in some embodiments, the container 50 shifts between the vertical portion 80 and the entry portion 78 without the need for an additional apparatus. However, as previously discussed, in other embodiments, an apparatus urges the container 50 toward the entry area 78. For example, as shown in FIG. 15, one or more rollers 242 can urge the container 50 toward the entry area 78. In certain embodiments, at least one pair of the rollers 242 are configured to turn in opposite directions (e.g., clockwise and counter-clockwise) to motivate the container 50 toward the entry area 78.

When the container 50 reaches the entry area 78, the container 50 can proceed through the sealed entry door 232 to enter the entry chamber 138 and be received into the cavity 233 of the body 232 of the gripper assembly 230. As previously discussed in additional detail, after the container 50 has entered the entry area 140, the entry door 232 can be closed and further preparation can be performed. For example, the water around the container 50 can be removed. Moreover, the grips 234 can be actuated so as to secure the container 50 in the gripper assembly 230.

As shown, in some embodiments, the lever arm 90 includes a space 243 defined by a guard 244. Generally, the space 243 is sized and shaped to receive the container 50 and the guard 244 is configured to protect the container 50 during the power stroke. For example, the guard 244 can be made of corrosion-resistant steel plates, bars, or grating. In certain arrangements, a first end 245 of the guard 244 is generally closed (e.g., the container 50 is not able to pass through the first end 245) and a second end 246 of the guard 244 is configured to be selectively opened and closed. For example, the guard 244 can have a door, gate, flap, or otherwise that can be opened to allow the container 50 pass into and out of the space 243 and closed to maintain the container 50 within the space 243.

As shown, an actuator 247 can be positioned at least partly in the space 243. For example, the actuator 247 can be electric, hydraulic, or pneumatic. The actuator 247 can include an extension member 248 with an end portion 249 that is configured to extend and retract along a portion of the lever arm 90. In some embodiments, the end portion 249 of the extension 284 is padded or otherwise configured to reduce the likelihood of damage to the container 50 during transfer from the gripper assembly 230 to the lever arm 90 as discussed in further detail below.

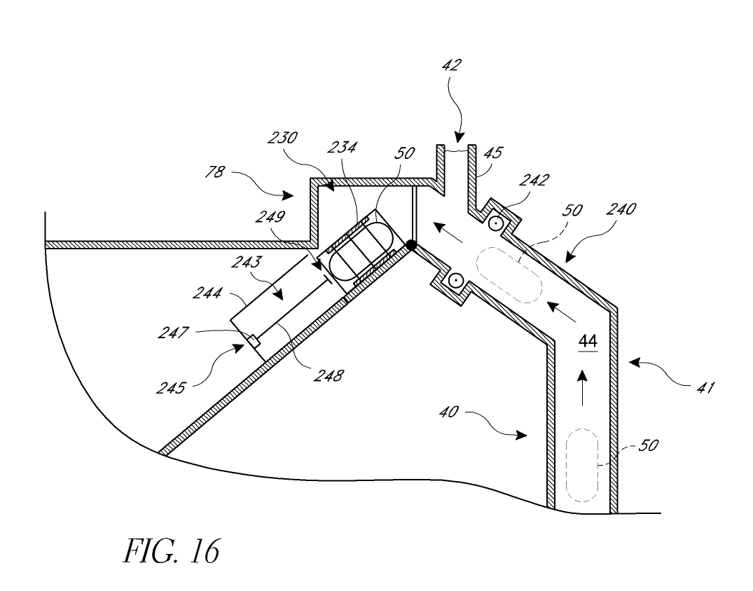

Turning to FIG. 16, after the container 50 has been received into the gripper assembly 230 and any prepatory steps (e.g., closing of the entry door 232, removal of water around the container 50, and closing the grips 234 to secure the container 50) are completed, the transfer process between the gripper assembly 230 and the lever arm 90 can be initiated. As shown, in some embodiments, the gripper assembly 230 can be allowed to rotate downward toward the lever arm 90. For example, the gripper assembly 230 can rotate so as to be substantially parallel with the lever arm 90. In some such cases, the cavity 233 of the gripper assembly 230 is substantially longitudinally aligned with the space 244 defined by the guard 244 on the lever arm 90.

In some embodiments, the grips 234 are configured to maintain the container 50 within the gripper assembly 230 at least until the gripper assembly has been rotated into alignment with the lever arm 90. For example, the grips 234 can have sufficient frictional force with the container 50 to inhibit or overcome the force of gravity, which tends to encourage the container 50 to fall out of the lower end of the rotated gripper assembly 230.

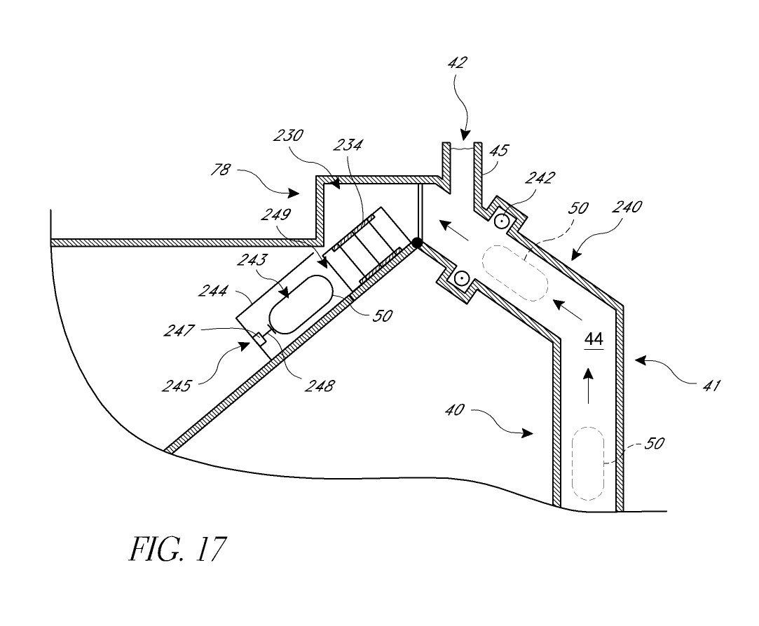

With regard to FIG. 17, in certain embodiments, when the gripper assembly 230 has been rotated into alignment with the lever arm 90, the grips 234 are opened, thereby allowing the container 50 to move toward the lower end of the gripper assembly 230, such as by force of gravity. For example, the container 50 can slide out of the gripper assembly 230 toward the guard 244 on the lever arm 90. In some instances, the container 50 contacts the end portion 249 of the extension member 248 of the actuator 247. Indeed, in certain configurations, gravity urges the container 50 against the end portion 249.

The actuator 247 can be configured to retract the extension member 248 toward the first end 245 of the guard 244, thereby allowing the container 50 to move into the space 243. Generally, the extension member 248 is retracted gradually. Such a configuration can, for example, reduce the likelihood of damage to the container 50, gripper assembly 230, and lever arm 90 as the container 50 is moved from the gripper assembly 230 to the lever arm 90. In some embodiments, the gripper assembly 230 is configured to automatically return to the position in the entry area 140 in order to receive another container 50. For example, the gripper assembly 230 can be upwardly biased with a spring. In some embodiments, one or more motors are configured to rotate the gripper assembly 230 (e.g., between the positions illustrated in FIGS. 15 and 17).

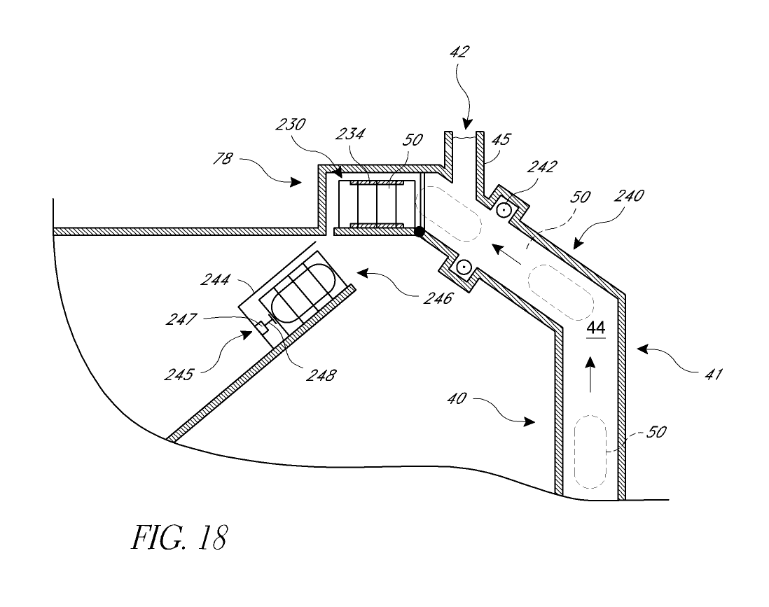

As shown in FIG. 18, after the container 50 has been received in the space 243, the power stroke is allowed to begin. Generally, the container 50 is maintained in the space 243 during the power stroke. For example, the second end 246 of the guard can be closed (e.g., with a door or gate) to inhibit or prevent the container 50 from exiting the space 243 during the power stroke. In other embodiments, the guard 244 includes grips (not shown), which can be similar to the grips 234 in the gripper assembly 230, and can be configured to secure the container 50 in the space 243 during the power stroke.

Upon completion of the power stroke, the container 50 can be urged from the space 243 and proceed to the exit area 79 of the hull 40, where the container 50 is ejected into the chamber 44 of the fluid column 41. For example, the container 50 can be urged from the space 243 by force of gravity or by the extension member 246. As previously discussed, the lever arm 90 can be configured to automatically move upwardly to return to the top of the hull 40 so as to receive another container 50, and perform another power stroke. Likewise, the extension member 246 can extend toward the second end 246 of the guard 244 in order to receive another container 50 (e.g., as shown in FIG. 15).

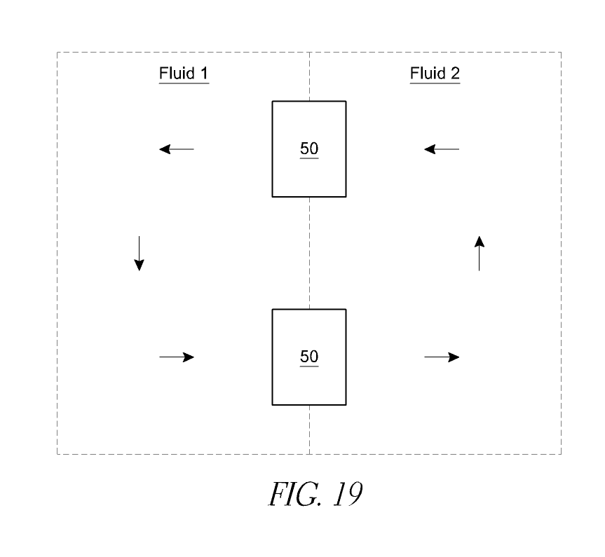

Turning now to FIG. 19, in certain embodiments, the power generator includes multiple containers 50, the movement of which are configured to balance or otherwise enhance the stability of the power generator. For example, as one container 50 passes from a first fluid to a second fluid (e.g., from air to water), another container 50 can substantially concurrently pass from the second fluid to the first fluid (e.g., from water to air). For example, the power generator can be configured such that, as water is being removed from a container 50 located in the entry chamber 138, another container 50 is substantially concurrently ejected into the water space 44. In other embodiments, as one container 50 moves from the exit area 79 toward the vertical portion 80 of the fluid column 41, another container 50 substantially concurrently moves from the vertical portion 80 toward the entry area 78. In certain arrangements, as one container 50 is being loaded into the entry chamber 138, a second container 50 is substantially concurrently loaded into the exit chute 140.

In certain embodiments, the power generator is configured to maintain a substantially constant volume of fluid in the fluid column 41. Such a configuration can, for example, increase the total efficiency of the power generator by reducing the losses (e.g., pumping losses) associated with adding water to the power generator. In some such embodiments, water that is removed from around the container 50 (e.g., when the container 50 is located in the entry chamber 138) is returned to the fluid column 41. In certain instances, the power generator is configured such that, as the entry door 232 is opened to allow a first container 50 into the entry chamber 138, a second container 50 is substantially concurrently ejected into the fluid column 41, such as is shown in FIG. 9.

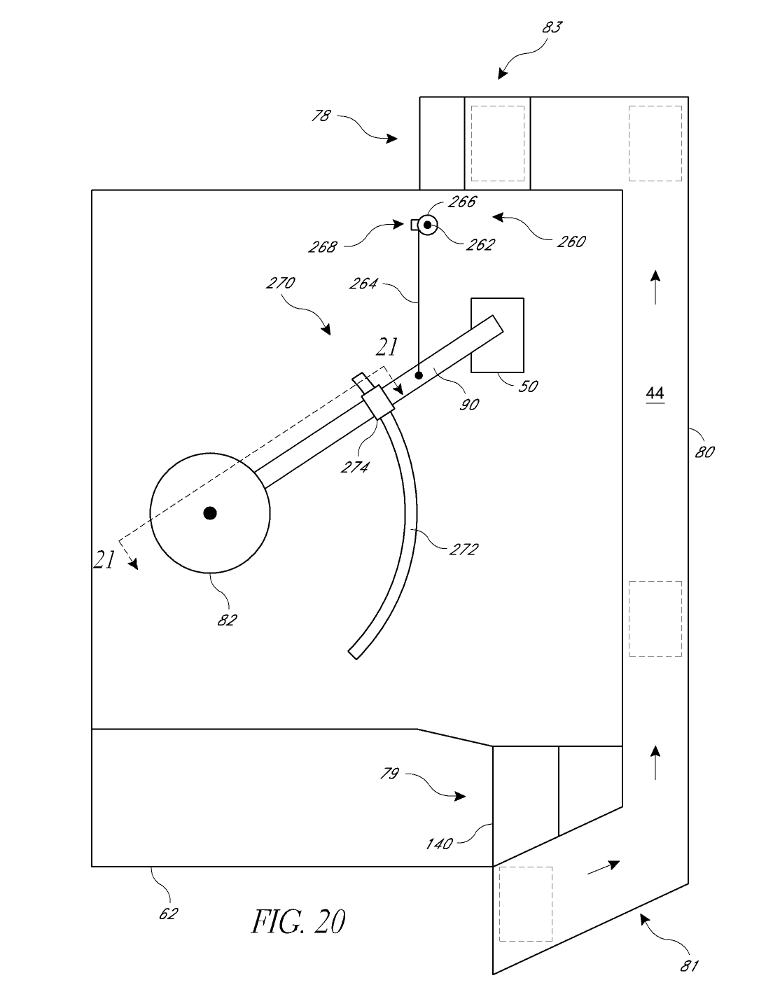

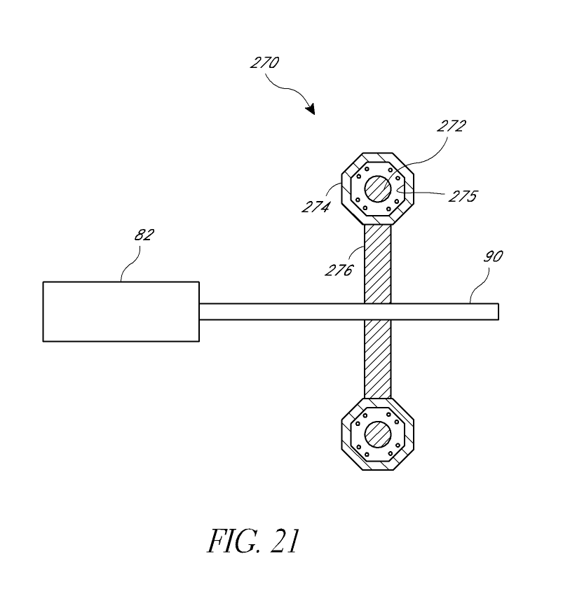

With reference to FIGS. 20 and 21, another power generator embodiment is illustrated. The power generator of FIGS. 20 and 21 is generally the same as the power generator of FIGS. 2-13 and 14-18, but with some differences, some of which are discussed below. For example, in some embodiments, the lower portion 81 of the fluid column 41 is sloped upward toward the vertical portion 80. In some such configurations, after the container 50 has been ejected from the exit chamber 140 and the outer hatch 146 (not shown) has been closed, the buoyancy of the container 50 can urge the container 50 toward the vertical portion 80, thereby eliminating the need for a separate apparatus to move the container 50 toward the vertical portion 80.

As further illustrated in FIGS. 20 and 21, some embodiments of the power generator include a support system for the lever arm 90. In certain arrangements, the support system includes a winch assembly 260 and/or a guide assembly 270. Such configurations can, for example, reduce lateral or horizontal movement of the lever arm 90 during the power stroke and/or the return stroke. Further, in some cases, such a configuration can reduce the stress on the lever arm 90, which can reduce the likelihood of failure of the lever arm 90 and/or damage to other components of the power generator.

In certain embodiments, the winch assembly 260 is configured to provide vertical support to the lever arm 90. As shown, the winch assembly 260 can include a pulley 262 and an elongate member 264. In some embodiments, the elongate member 264 is a chain, wire, rope, cable, or other object configured to resist a longitudinal tension force. One end of the elongate member 264 can connect with the lever arm 90 and the other end can connect with the pulley 262. For example, one of the ends of the elongate member 264 can be looped with a ferrule, and a bolt can be passed through the loop and into the lever arm 90. As shown, in some cases, the elongate member 264 connects with the lever arm 90 near the second end 94 of the lever arm 90.

In some embodiments, the elongate member 264 is configured to wind onto, and unwind from, a spool portion 266 of the pulley 262. For example, the elongate member 264 can unwind from the spool portion 266 as the lever arm 90 moves through a power stroke. In some such cases, the winch assembly 260 includes a brake 266, which inhibits the unwinding of the elongate member 264 under certain conditions. For example, the brake 266 can be configured to inhibit unwinding of the elongate member 264 after a certain linear length of the elongate member 264 has been unwound (e.g., about 50 feet, about 100 feet, or about 200 feet). As another example, the brake 266 can be configured to inhibit unwinding of the elongate member 264 after the lever arm 90 has passed through a certain portion of the power stroke (e.g., about 60%, about 75%, about 90%). Such configurations can provide, for example, a gradual reduction of the speed of the lever arm 90 as the lever arm 90 nears the end of the power stroke, which can reduce vibration, increase the fatigue life of the lever arm 90, and lessen the chance of the container 50 being unintentionally separated from the lever arm 90. Further, as some of the force needed to stop the downward movement of the lever arm 90 and the container 50 can be provided by the elongate member 264, the lever arm 90 can be configured to be thinner and/or lighter. In further embodiments the brake 266 can bee coupled with an electricity generator so as to produce electricity while electromagnetically braking the fall of the container. In some such embodiments the brake can be computer-controlled so as to regulated the speed of descent of the container while simultaneously generating electricity.

In some cases, the elongate member 264 winds onto the pulley 262 as the lever arm 90 returns to the upward position (e.g., as shown in FIG. 20). The pulley 262 can be biased to turn the pulley 262 to wind the elongate member 264 onto the pulley 262. For example, the pulley 262 can be biased with a torsion spring. In certain arrangements, the lever arm 90 is returned to the upward position by the winding of the elongate member 264.

In some embodiments, the pulley 262 is configured such that rotation of the pulley 262 generates electricity. For example, the pulley 262 can be connected with the flywheel 82 so as to drive the flywheel 82, such as through gearing and/or a transmission. In some embodiments, as the lever arm 90 goes through a power stroke, the elongate member 264 is unwound from the spool portion 266 of the pulley 262 and such rotation of the pulley 262 is converted into electrical energy. In certain embodiments, as the lever arm 90 moves from the end of the power stroke to the upward position, the bias of the pulley 262 winds the elongate member 264 onto the spool portion 266 and such rotation of the pulley 262 is converted into electrical energy.

In certain embodiments, the guide assembly 270 is configured to provide lateral or horizontal support to the lever arm 90. The guide assembly 270 can include a rail 272 that is secured to the hull 40 and is curved to substantially correspond with the arc that a point on the lever arm 90 traverses during the power stroke. A follower 274, which is connected with the lever arm 90 by a support member 276, can be configured to traverse along the rail 272 during movement of the lever arm 90. Generally, as the lever arm 90 moves through the power stroke, the follower 274 traverses downwardly along the rail 272. As the lever arm 90 returns to the upward position, the follower 274 traverses upwardly along the rail 272. Thus, the guide assembly 270 can provide lateral and horizontal support to the lever arm 90 throughout its travel. Such support can, for example, inhibit lateral or horizontal movement of the lever arm 90, such as may be caused by non-vertical forces (e.g., wind, waves, earthquakes, impact from objects, etc.).

As shown in the top cross-sectional view of FIG. 21, in some embodiments, the guide assembly 270 includes a plurality of rails 272 and followers 274. For example, a rail 272 and a corresponding follower 274 can be arranged on each side of the lever arm 90. Such a configuration can, for example, enhance the support provided to the lever arm 90.

In certain instances, movement of the follower 272 along the rail 274 is facilitated by rollers 277 on an interior 275 of the follower 274. In other embodiments, the interior 275 includes bearings, bushings, or is otherwise configured to ease movement of the follower 274 along the rail 272. In still further embodiments, movement of the follower 274 along the rail 272 is aided by oil, grease, or other lubricants.

In the illustrated embodiment, the rail 272 is circular and the follower 274 is octagonal in cross-sectional shape. However, many other cross-sectional shapes for each of the rail 272 and the follower 274 are contemplated and are included in this disclosure, such as: elliptical, square, diamond, rectangular, triangular, pentagonal, hexagonal, octagonal, C-shaped, H-shaped, I-shaped, T-shaped, V-shaped, star-shaped, irregular, or otherwise. In some embodiments, the rail 272 and the follower 274 share a common cross-sectional shape. In other embodiments, rail 272 and the follower 274 have dissimilar cross-sectional shapes, such as is shown in FIG. 21.

In certain instances, the follower 274 is at least partly mated with the rail 272. For example, the rail 272 can have a cross-sectional V-shape and the follower 274 can have a corresponding cross-sectional V-shape, so as to allow the rail 272 and the follower 274 to mate. Such mated configurations can, for example, reduce the likelihood that the follower 274 will become derailed from the rail 272.

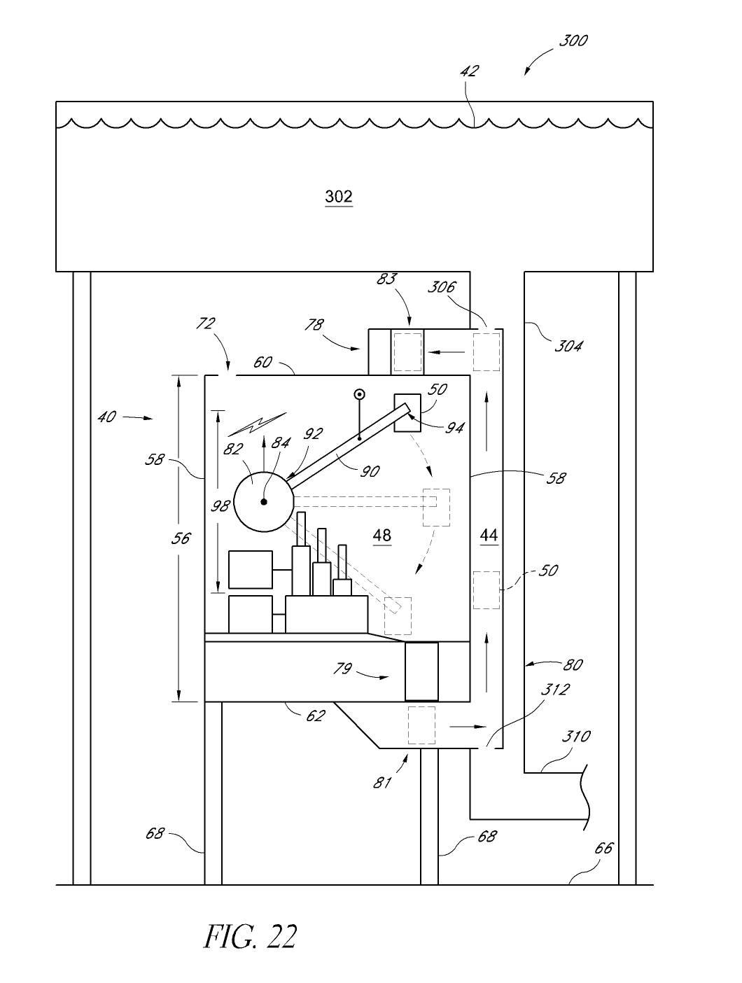

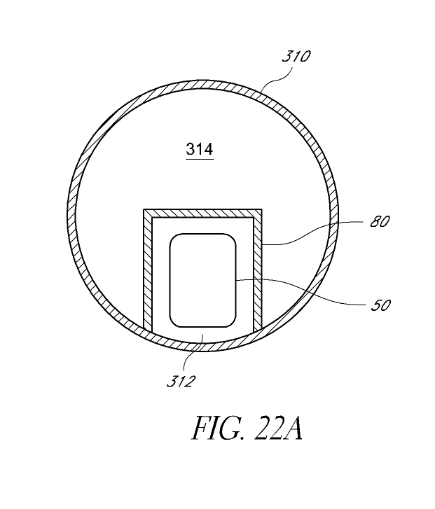

With regard to FIG. 22, an embodiment of the power generator is illustrated in use with an elevated tank 300 holding a volume of fluid. For example, the elevated tank 300 can be a municipal water tower. In some embodiments, the tank 300 is configured to distribute water under pressure to a surrounding area, e.g., a community, factory, industrial plant, or otherwise. An interior space 302 of the tank 300 can be in fluid communication with the fluid column 41 of the power generator via a pipe 304. As shown, an aperture 306 can be disposed at the intersection of the pipe 304 and the fluid column 41. In some embodiments, the aperture 306 is configured to inhibit the container 50 from entering the pipe 304. For example, the aperture 306 can be dimensioned to be smaller than the container 50 and/or can include a screen, bars, or the like.

In some embodiments, the fluid column 41 is also in fluid communication with another pipe 310 via an opening 312. Similar to the aperture 306 discussed above, the opening 312 can be configured to inhibit the container 50 from passing into the pipe 310. As shown, the pipe 310 is located toward the bottom of the fluid column 41. However, in other arrangements, the pipe 310 connects with the fluid column 41 in other locations, such as near the top of the fluid column 41. In certain instances, the pipe 310 is an inlet pipe, whereby fluid passes from the pipe 310 into the fluid column 41 and eventually into the tank 300. For example, the pipe 310 can connect to pumps or piping that supply water to the water tower, thus allowing the water to flow through the pipe 310 and into the tank 300 via the fluid column 41. In other embodiments, the pipe 310 is an outlet pipe, whereby fluid in the tank 300 flows out of the pipe 310 via the fluid column 41. For example, the pipe 310 can connect to piping that supplies water from the water tower to users. In still other embodiments the pipe 310 extends only from the tank 300 to the aperture 306, and a separate pipe supplies water from the tank 300 to users.

In certain embodiments, at least a portion of the vertical portion 80 is positioned within the pipe 310. For example, a portion of the pipe 310 can be substantially vertical and at least some of the vertical portion 80 can be located in such vertical portion of the pipe 310. As shown in the cross-sectional view of such a pipe 310 illustrated FIG. 22A, the vertical portion 80 can be a fenced or otherwise defined sub-portion 312 of the total interior area 314 of the pipe 310. In some such embodiments, the vertical portion 80 of the fluid column 41 includes a plurality of holes to allow water to freely pass between the sub-portion 312 and rest of the total interior area 314. For example, the vertical portion 80 can be made of grating or fencing. In other embodiments, water can only selectively pass between the sub-portion and the rest of the total interior area 314. For example, the chamber 44 can be sealed from the pipe 310 except for one or more valves that may be selectively opened to allow water to flow from the pipe 310 to the chamber 44 or vice versa.

In certain embodiments, the vertical portion 80 is configured to be similarly dimensioned as the container 50. Such configurations can, for example, provide control of the container 50 within the total interior area 314 of the pipe 310 as the container 50 ascends (e.g., can promote substantially vertical ascent with limited horizontal movement). Also, as the total interior area 314 can be larger than the sub-portion 312, the total throughput of water through the pipe 310 can be greater than if the pipe 310 was limited to the size of the sub-portion 312. Furthermore, configurations in which the vertical portion 80 defines the sub-portion 312 within the pipe 310 can allow the power generator to be retrofitted into existing elevated tank systems, since specialized dimensions (e.g., similar to the dimensions of the container 50) for the pipe 310 are not required.

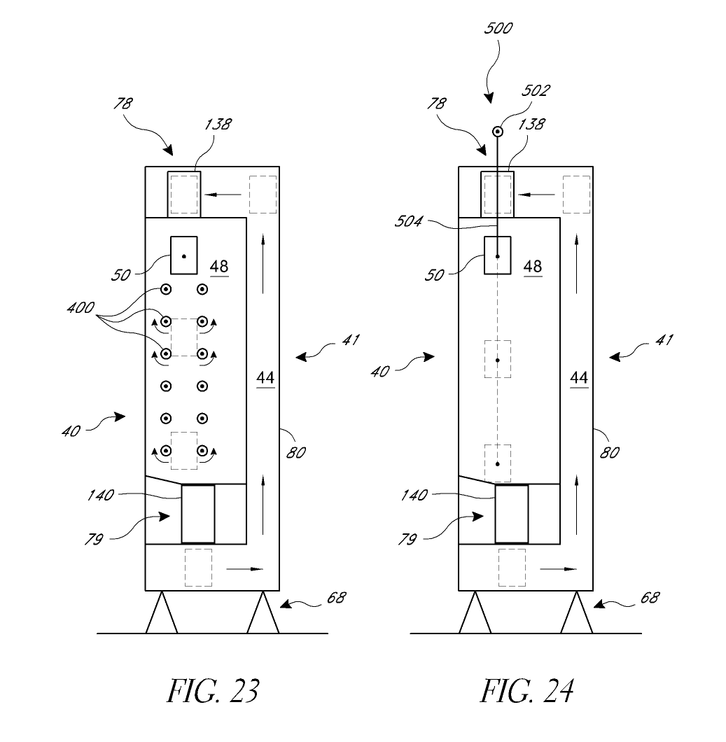

With reference to FIG. 23, another embodiment of a power generator is illustrated. As shown, the entry chamber 230 and exit chute 140 are substantially aligned such that the container 50 falls along a generally vertical shaft or path from entry to exit. In some embodiments, a plurality of rollers 400 are disposed along the fall path. As the container 50 falls, it contacts and turns the rollers 400 that, in turn, drive generators (e.g., electricity generators). In some embodiments, each of the plurality of rollers 400 drives its own electricity generator in a manner similar to automotive regenerative braking systems. In other embodiments, rotation of the plurality of rollers 400 drives a common shaft (not shown) which, in turn, drives an electricity generator.

In another embodiment, magnetic poles are disposed along the fall path and on the container 50. In such cases, when the container 50 moves along the fall path, the poles of the container 50 pass by the poles disposed along the fall path, thereby inducing an electric charge. Thus, such a configuration can act as a linear electricity generator. Certain embodiments of the power generator can employ a combination of the rollers 400 and the magnetic poles, or can employ a guide structure having poles and/or coils through which the container 50 falls. In some embodiments the poles and coils of the linear electricity generator are chosen so that the descent speed of the container 50 is controlled/braked by the electricity-generating function. In some such embodiments the linear electricity generator is computer-controlled so as to regulate and control container descent speed.

With continued reference to FIG. 23, once the container 50 nears or reaches the bottom of the fall path, the container 50 can be urged into the exit chute 140. As discussed above, the container 50 can proceed through the exit chute 140 and into the chamber 44 of the fluid column 41. The container 50 can then be urged to the vertical portion 80 of the fluid column 41 and the container 50 can undergo a buoyancy change. Due to this buoyancy change, the container 50 ascends through the vertical portion 80. Upon reaching approximately the apex of the vertical portion 80, the container 50 may be moved into the entry chamber 230, where additional steps may be performed, such as removing the water surrounding the container 50 in the entry chamber 138. The container 50 may then begin the cycle anew.

With regard to FIG. 24, another embodiment of a power generator is illustrated. As shown, the power generator can include a winch system 500. In some respects, the winch system 500 is similar to the winch assembly 260 described above. For example, the winch system 500 can include a pulley 502 and an elongate member 504. As shown, one end of the elongate member 504 can connect with the container 50. For example, the elongate member 504 can connect with the container 50 while the container 50 is within the entry chamber 138.

In some embodiments, the container 50 is allowed to fall along a fall path from the entry chamber 138 generally toward the exit chute 140. As the container 50 drops, it pulls with it the elongate member 504, which thereby unwinds from the pulley 502 and rotates the pulley 502 in the process. In some embodiments, the pulley 502 is connected to a flywheel 82, such as the flywheel 82 discussed above, or otherwise connected to an electrical generator. Thus, the rotation of the pulley 502 can encourage the generation of electricity. The generator can also be configured to brake the falling container so as to regulate container descent velocity.

In certain embodiments, when the container 50 nears the end of the fall path, the pulley 502 and/or elongate member 504 can be braked or otherwise slowed in order to decrease the rate of descent of the container 50 and/or the rate of unwinding of the elongate member 504 from the pulley 502. The container 50 can be disconnected from the elongate member 504 and can be allowed to proceed toward the exit chute 140. Also, after being disconnected from the container 50, the elongate member 504 can be rewound onto the pulley 504, such as by the bias of a spring (e.g., a torsion spring), motor, or otherwise. Accordingly, the elongate member 504 can be returned approximately to its initial position and able to connect with another container 50 located in the entry chamber 138. In some embodiments the descent velocity of the container is controlled through the entire fall by electricity-generating braking. In some embodiments such braking is controlled by a computer.

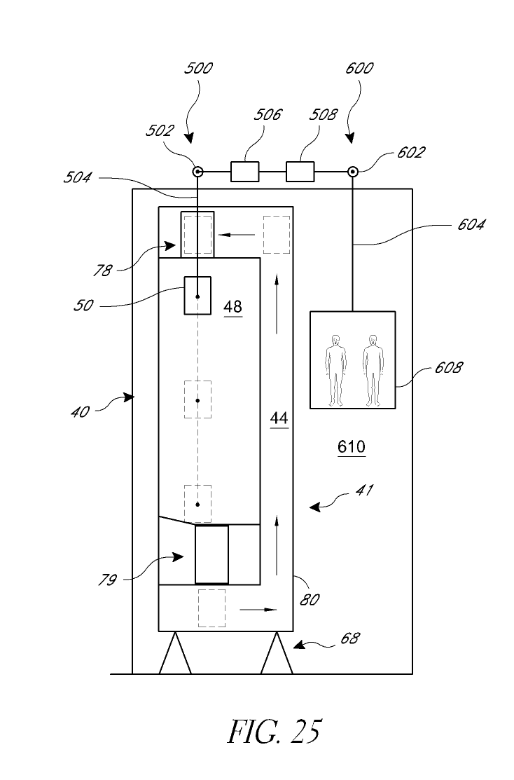

In some embodiments, the configurations of FIGS. 23 and 24 can be particularly beneficial in applications with relatively narrow space constraints, such as instances in which the height of the vertical portion 80 is substantially greater than the width and depth of the power generator. For example, FIG. 25 illustrates an embodiment of the power generator of FIG. 24 in an elevator shaft. Generally, elevator shafts have a height dimension which is substantially greater than the width and depth of the elevator shaft. For example, an elevator shaft may be about ten feet wide and about ten feet deep, and have a height of tens or hundreds of feet. In contrast, the rollers 400 can be positioned in, and/or the winch system 500 can be positioned above, the fall path of the container 50, e.g., the elevator shaft. Thus, the rollers 400 and/or winch system 500, as discussed in FIGS. 23 and 24, can provide a compact alternative configuration for the power generator. Further, such power generators can be installed in elevator shafts or other shafts in mid- to high-rise office or residential buildings so as to provide electricity for the building and/or for providing electricity to the grid.

As shown in FIG. 25, certain embodiments of the power generator are configured to drive an elevator system 600. For example, the winch system 500 can include a clutch 506 and/or a transmission 508, which can transfer rotational energy to the elevator system 600. In some instances, during a power stroke of the generator, the pulley 502 is rotated. Such rotational energy can be transferred to the clutch 506 and/or transmission 508, which in turn transfers the rotational energy to a spool 602 of the elevator system 600. Rotation of the spool 602 can wind and unwind a cable 604 that is connected with a car 608 that is configured to hold one or more persons or things. Accordingly, rotation of the pulley 502 of the winch system 500 can raise and lower the car 608 within an elevator shaft 610.

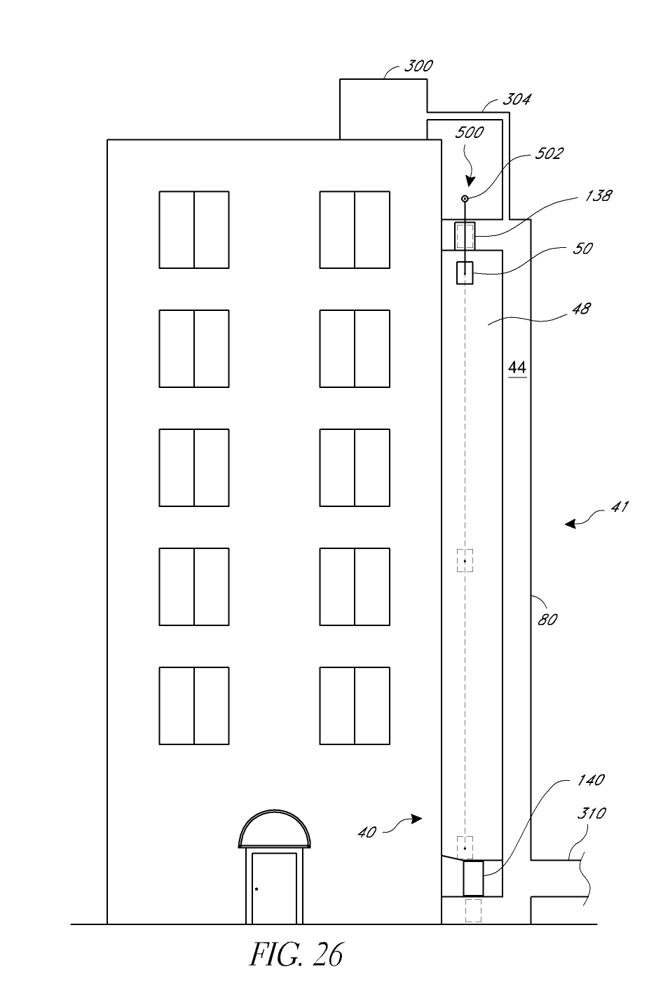

With regard to FIG. 26, another embodiment of a power generator is illustrated. As shown, the power generator can be located on the outside of a vertical structure, such as a building. In some instances, the vertical structure is a commercial structure, such as an office building. In other cases, the vertical structure is a residential structure, such as a multi-family building (e.g., a building of apartments or condominiums). In yet other embodiments, the vertical structure is a single-family home. In still further instances, the vertical structure is an industrial structure, such as a refinery, manufacturing facility, or warehouse. Further, although FIG. 26 illustrates the power generator outside the vertical structure, it is to be understood that other configurations are contemplated and are part of this disclosure. For example, the power generator can be located inside the vertical structure, such as in an elevator shaft, garbage or laundry chute, wiring or ductwork chase, chimney, or other type of vertical shaft.

In some embodiments, the vertical structure includes an elevated tank 700 (or a similar elevated tank such as the water tower described in FIG. 22), which can be used for providing water to the occupants of the vertical structure, such as at taps and faucets. In some instances, the tank 700 is located on an upper level or the roof of the vertical structure. Generally, water is supplied to the tank 700 by a pumping system, which drives or otherwise urges water from a pipe 710 up to the tank 700 via the fluid conduit 41. As such, part of the operational costs of the vertical structure are the costs associated with powering the pumping system. The power generator, by taking advantage of the buoyancy of the container 50 in relation to the water flowing up to the tank 700, and thereafter dropping the container 50 (such as by using a winch system 720, which can be the same or similar to the winch system 500 described in FIG. 24) in a power stroke to generate energy, can thus reclaim at least some of the pumping energy exerted to elevate the water.

In certain instances, the power generator can be employed in a power plant, such as a nuclear reactor. Nuclear reactors generally include, or have in the near vicinity, an elevated tank of water (e.g., water for cooling spent fuel rods). In some embodiments, this tank can be fluidly connected with the fluid column 41 of the power generator for cycling containers 50 into and out of, in conjunction with power strokes and buoyancy-driven return strokes, to generate electricity. Thus, even when the reactor portion of the plant is not operating, power can be produced to operate, for example, pumps to provide cooling water to the reactor. Such a configuration can, for example, reduce the chance of and/or avoid a potential catastrophic event, such as a meltdown or other release of radiation. Furthermore, such an example shows that the power generator can use radioactive or otherwise contaminated fluid.

The embodiments disclosed above demonstrate various principles, features and aspects in connection with certain embodiments of a power generator. It is to be understood, however, that the principles described herein can be applied with other structures employing the principles described herein. For example, the illustrated embodiments illustrate some structural examples. It is to be understood that Applicants have contemplated other mechanical structures having somewhat different structures than shown specifically herein but still employing principles discussed herein. Further, other embodiments may employ still different shapes and sizes. For example, in other embodiments, the hull 40 can have non-rectangular shapes and the container 50 can be spherical and/or include fins.

The features and principles discussed in the illustrated embodiments above and below have been discussed in the context of a fluid column 41 substantially enclosing a volume of water and a hull 40 substantially enclosing an air space 48 therewithin. It is to be understood that the principles discussed herein can be employed in other environments having a first and a second fluid, wherein the first and second fluids have different densities. For example, the hull 40 can hold a first fluid having a relatively light density and the fluid column 41 can hold a second fluid having a greater density than the first fluid. Weighted containers 50 can be cycled through, into, and out of the hull 40 to generate power strokes (which can be converted to electrical energy) as disclosed above.

In the illustrated embodiment, the pressurized air system was depicted as having a plurality of tanks. It is to be understood that the pressurized air system can involve more or fewer tanks as desired. For example, tanks can be provided having specific ranges of pressurized air that are optimized for operating and driving particular tools. In some instances, a plurality of valves and sensors directed by a controller can be provided for distributing pressurized air to the tanks in a controlled manner.

As discussed above in connection with FIG. 26, a power generator can advantageously be employed in the context of a vertical structure, such as a residential or commercial building. It is to be understood that industrial applications such as water treatment facilities, manufacturing facilities, foundries, and the like can also employ principles discussed herein. Further, certain embodiments of the power generator can be configured for relatively small scale applications. For example, rather than the multiple-story building illustrated in FIG. 26, the power generator can be configured for use with a single story or double-story building. Certain embodiments of the power generator can advantageously be employed in conjunction with manmade or natural topographic features, such as quarries (e.g., abandoned), cliffs, hills, mountains, valleys, gorges, waterfalls, and otherwise. In some such embodiments, reconfiguring the topographic features creates a manmade reservoir of fluid with depth sufficient for the buoyant stroke.

Furthermore, as discussed in connection with FIG. 2A, certain embodiments of the power generator are configured to be readily movable. Although the power generator illustrated in FIG. 2A is on the back of a trailer, it is to be understood that a variety of other bases (such as a pallet, pontoons, girders, or otherwise) and transportation methods (such as by boat, helicopter, airplane, or otherwise) are contemplated and are part of this disclosure. In certain embodiments, the power generator can include one or more features to facilitate moving the power generator. For example, the power generator can include wheels to allow the power generator to be rolled or driven (e.g., by rotational energy diverted from the flywheel to one or more drive wheels). As another example, the power generator can include a plug or the like to allow the fluid in the fluid column to be drained to reduce the weight of the power generator during transport; the fluid column can be refilled (e.g., with seawater) after the power generator arrives at the desired destination.

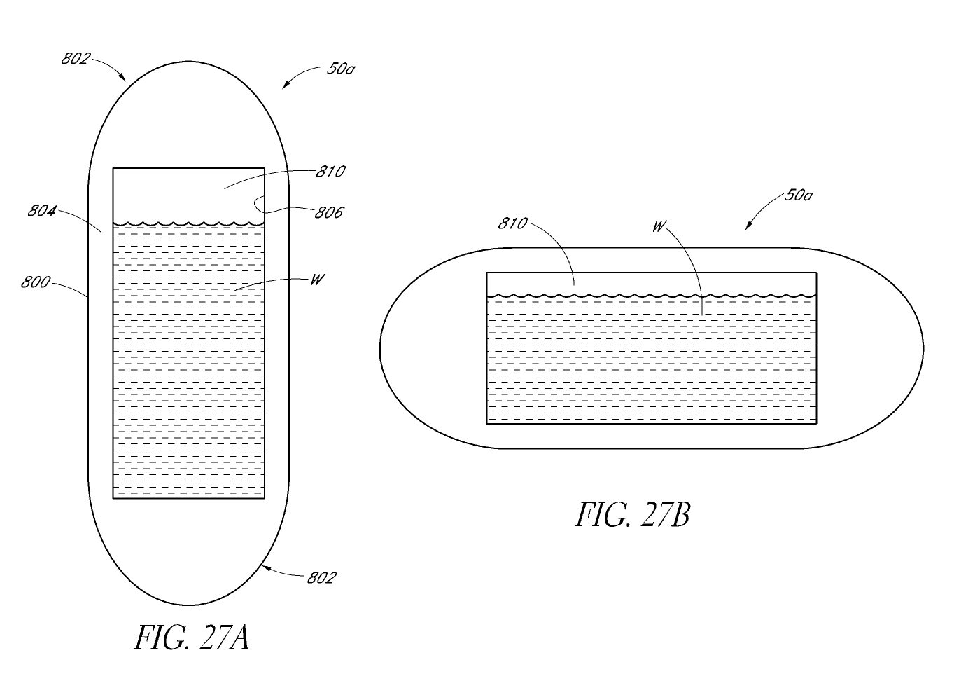

With reference next to FIGS. 27A and 27B, another embodiment of a shaped container 50a is illustrated. In the illustrated embodiment, the container 50a is substantially torpedo-shaped. The container has an elongate cylindrical body 800 and opposing end caps 802. Preferably the end caps 802 are curved so that each end of the container 50a presents a curved surface. The cylindrical body 800 comprises a shell 804 that defines an interior space 806. Preferably the interior space 806 is mostly filled with water w, but also includes an air pocket 810. Preferably the air pocket 810 is sized so that the container 50a is buoyant when placed in a body of water. As shown, when moving between a vertical orientation and the horizontal orientation, the air space 810 moves so as to always maintain an upwardly buoyant configuration for the container 50a.

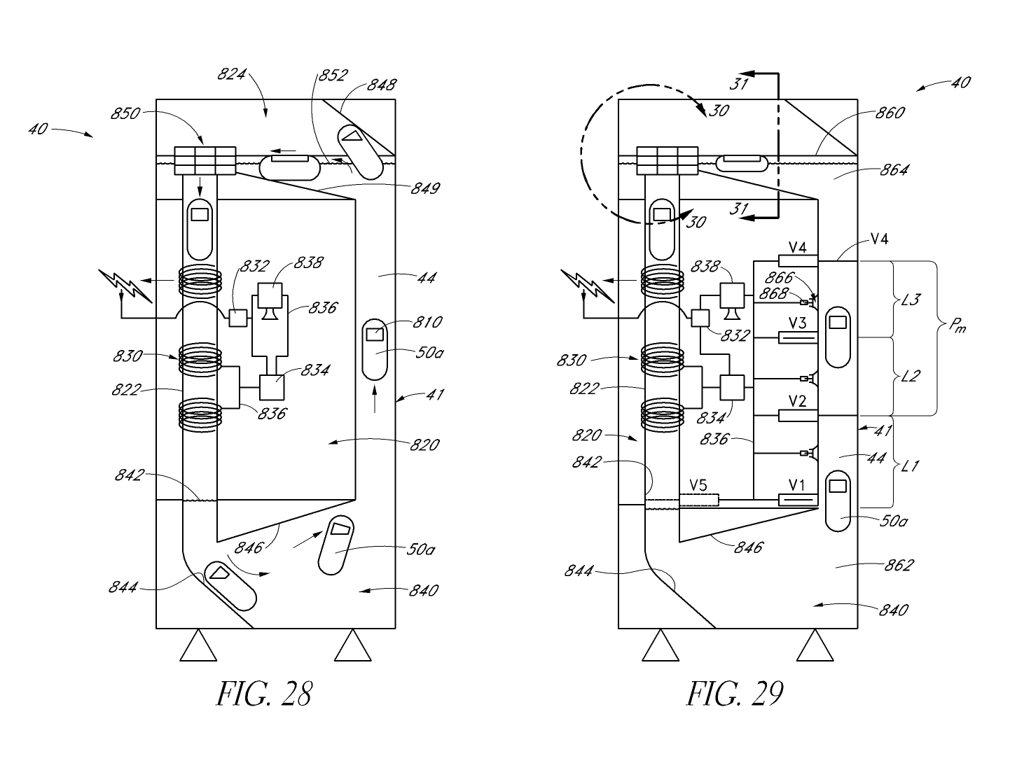

With reference next to FIG. 28, another embodiment of a power generator comprises a hull 40 that encloses a pressurized air space 820 and a water space 840. The pressurized air space 820 comprises a descent tube 822 and an upper airspace 824. The descent tube 822 is sized and configured to accommodate containers 50a descending therethrough, and can be made up of guides arranged so as to maintain alignment of the falling containers 50a.

In the illustrated embodiment, the descent tube 822 includes in a linear electricity generator 830 comprising a plurality of coils and/or magnets. Coils and/or magnets are also provided on each container 50a. As the container falls through the tube 822 electricity is generated via the linear electricity generator 830. Such electricity can be stored in a battery 832 and/or directed off-site. The battery in turn can provide electricity to run an air compressor 836 and a computer 834, which may control operation of the coils so as, for example, to maximize electricity generation efficiency and/or apply braking to the container 50a as it falls. In the illustrated embodiment, control lines 836 extend from the computer to the coils and air compressor 838. The air compressor 838 preferably maintains the pressure within the pressurized air space 820.

The water space 840 includes a water column 41. As in other embodiments, the containers 50a buoyantly float upwardly within a water chamber 44. Descending through the tube 822 exits the air space 820 and enters the water space 840 at a tube exit 842. Preferably, the pressurized air space 820 is kept at a sufficient pressure to offset the water pressure at the tube exit 842. Thus water does not enter the air space 820. Preferably the container 50a maintains sufficient momentum from falling through the tube 822 so that it falls through the tube exit 842.

Once the falling container 50a enters the water space 840 preferably it is urged out of alignment with the tube 822 by a deflector 844. When the container's downward momentum stops, buoyant forces take over and the container 50a floats upwardly. The container may bump up against a slanted guide 846, which directs the container 50a to the vertical water chamber 44. Preferably the bottom guide 846 and deflector 844 are coated with a substantially slippery material such as ultra high molecular weight polyethylene (UEMWPE) so that containers 50a bumping into the guides will be urged as desired without significant frictional resistance.

Once the container 50a breaks the water surface 852 near the top of the hull 40, a slanted top guide 848 directs the container 50a to a horizontal disposition and toward a transfer mechanism 850. The bottom guide 849 also helps urge the container 50a to the horizontal disposition. In some embodiments, the containers have sufficient momentum from rising through the chamber 44 that the containers flow toward and into the transfer mechanism 850. An embodiment of the transfer mechanism 850 will be discussed in more detail below.

With reference next to FIG. 29, another embodiment of a power generator also employs a pressurized air space 820, a water space 840 and containers 50a falling through a tube 822 that has a linear electricity generator 830. In this embodiment, a plurality of knife valves v1-v4 are disposed in the chamber 44 so as to divide the water space 840 into several parts that do not communicate pressure to one another. As such, the valves v1-v4 disrupt and limit head generated by the water column 41, drastically decreasing the pressure at which the pressurized air space 820 must be maintained in order to offset water pressure to prevent water from entering the interface 842.

In the illustrated embodiment, when valve V1 is closed, the tube exit 842, which preferably is maintained as an open interface 842 between the air space 820 and water space 840 is at about one atmosphere. In other embodiments, other pressure configurations can be employed.

With continued reference to FIG. 29, a plurality of locks L1-L3 are disposed between adjacent valves V1-V4. In order to allow a container to pass, each valve must be opened. Preferably, however, when valve is open, valves immediately above and below the open valve are kept closed. Thus a maximum water pressure Pm, or maximum head, is limited. Preferably the pressurized air space 820 is maintained at about the same pressure as the maximum head Pm so as to prevent water incursion into the air space 820.

In some embodiments, one or more volume compensators 866 are provided in the locks between valves. As such, when a container 50a moves between locks, water volume that may change due to movement of the container 50a can be maintained. Preferably the compensators 866 comprise an actuator such as a ram 868 to control water volume. Also, preferably the valves v1-v4 and compensators 866 are regulated or controlled by the computer 834 to maximize effectiveness.

In some embodiments another knife valve v5 can be employed at the interface 842 and can be closed when the first valve V1 is opened. In other embodiments, the pressurized air space 820 is kept at a pressure sufficient so that such a valve is not necessary.

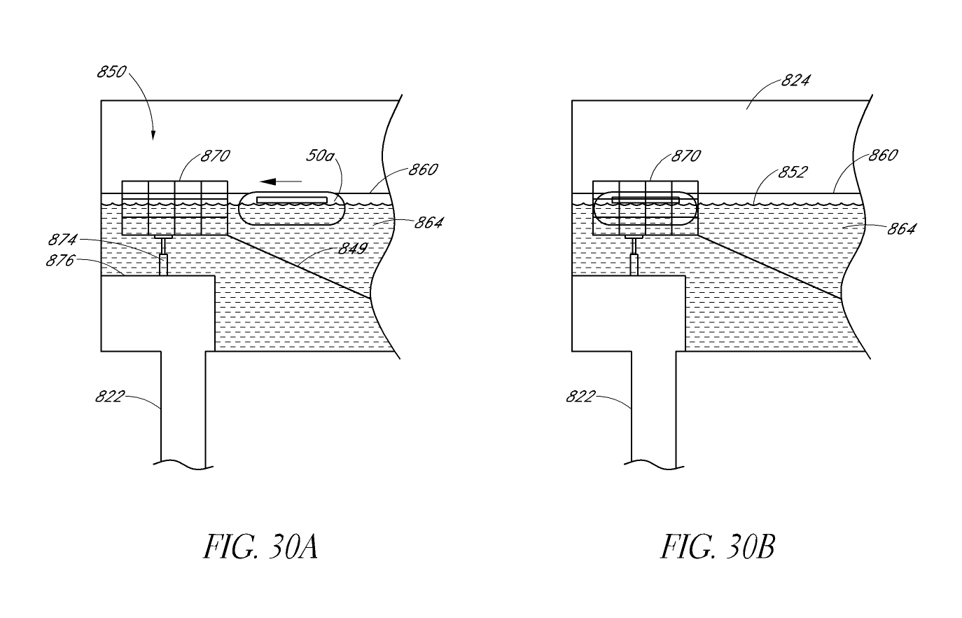

With reference next to FIGS. 30A and 30B, an embodiment of a transfer mechanism 850 is illustrated. When a container 50a is in the upper water chamber 864 floating at the water surface 852, it is directed into a water-side cradle 870 of the transfer mechanism 850. The waterside cradle 870 is partially supported by a transfer ram 874 which is supported by a platform 876. Preferably the water-side cradle 870 is formed of a mesh or the like so as not to retain water therein.

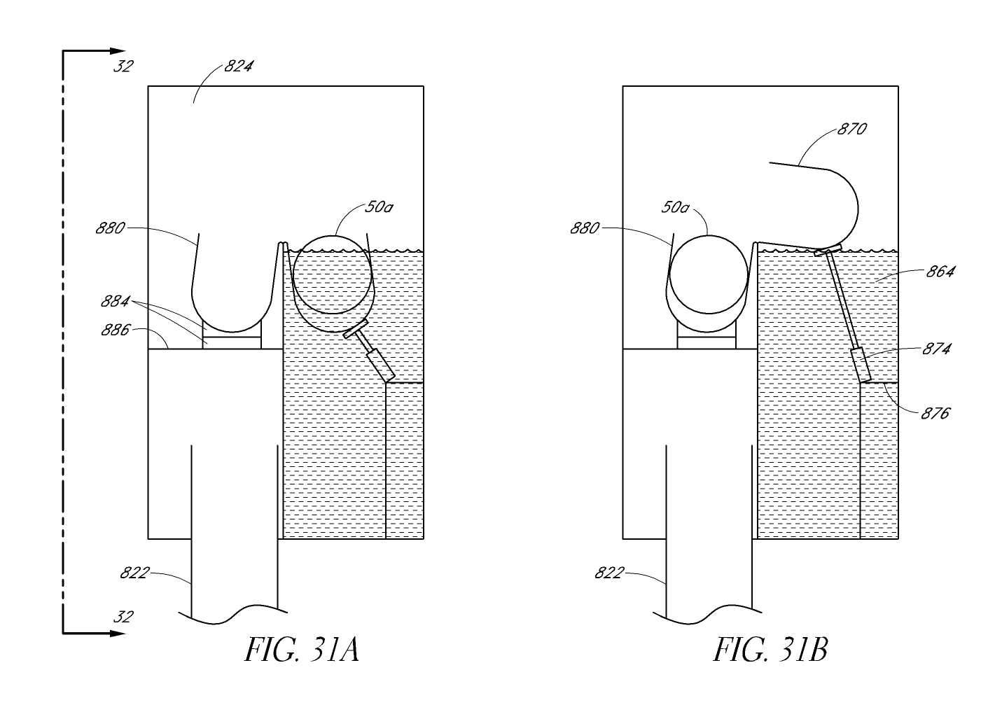

With reference next to FIGS. 31A and 31B, the water-side cradle preferably is connected to a top edge of an upper space divider wall 860 by a hinge 882. An air-side cradle 880 is arranged on the opposite side of the divider wall 860 from the water-side cradle 870. Once the container 50a is secure in the water-side cradle 870, the transfer ram 874 is actuated to rotate the water-side cradle upwardly so that the container 50a rolls and falls into the air-side cradle 880.

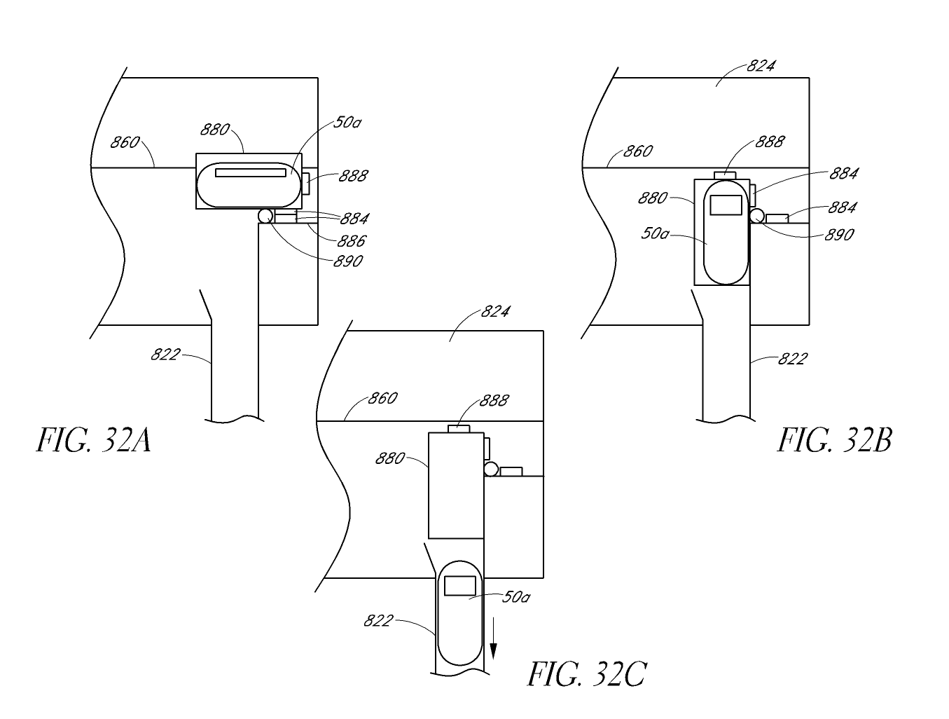

With reference next to FIGS. 32A-32C, preferably the air-side cradle 880 is supported on a cradle platform 886 and connected to the platform 886 via a hinge 890. Electromagnets 884 on the platform 886 and cradle 880 hold the cradle 880 in place. In some embodiments an electromagnet 888 can also hold the container 50a in place within the cradle 880. It is to be understood that, in other embodiments, other types and configurations of mechanisms for holding and rotating the air- and water-side cradles can be employed.

To deploy the container 50a into the tube 822, the electromagnets 884 can be disengaged and/or reversed, thus rotating the cradle and aligning the container 50a with the tube 822. The cradle electromagnet 888 can then be disengaged, allowing the container 50a to fall into the tube 822.

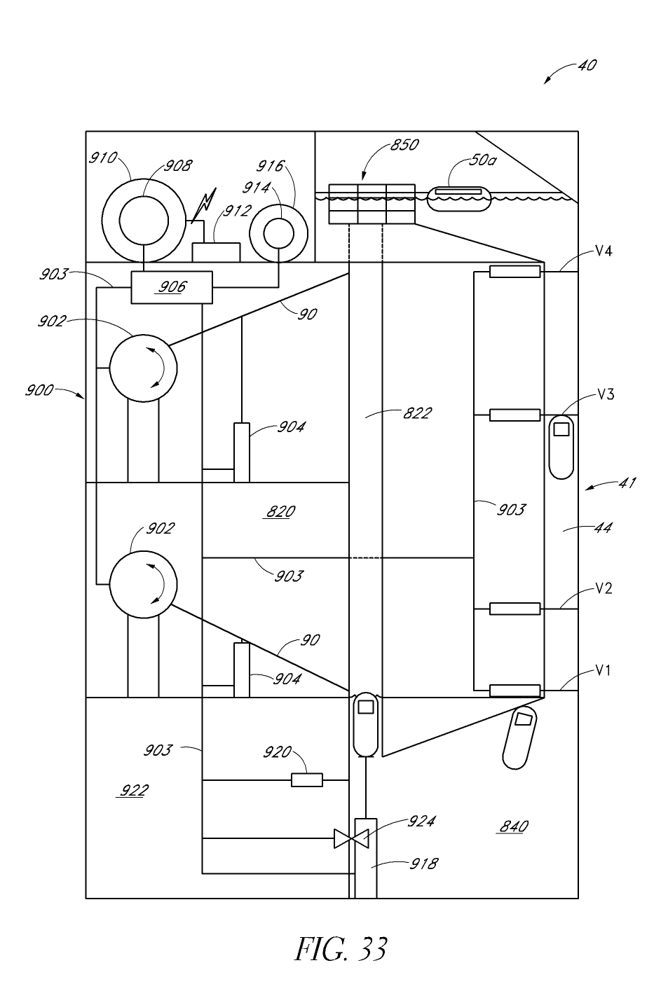

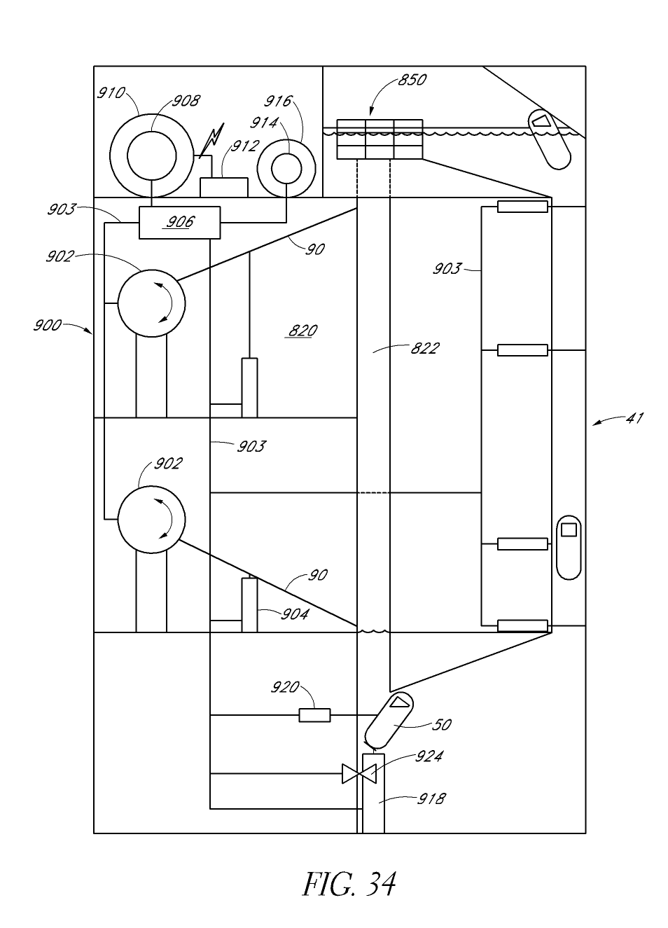

With reference next to FIGS. 33 and 34, in another embodiment of a power generator, containers 50a descend through a tube 822 or guide, but are connected to lever arms 90, and thus drive hydraulic pumps 902 as they fall. In the illustrated embodiment, power generation is modular, in that after descending while supported by one arm 90 the container 50a is transferred to another arm/pump 902 combination. Each such section is consider a power generation module 900, and in this embodiment each module can be separately constructed and joined together. The module 900 may also include the water chamber 44 side, including valves v1-v4.

In the illustrated embodiment, the hydraulic pump communicates pressure through hydraulic lines 903 to a tank 906, from which pressure is supplied to a hydraulic motor 906 that drives an electricity generator 910. Electricity can then be supplied to a battery 912 or delivered off-site. Hydraulic pressure also drives a hydraulic motor 914 that drives an air compressor 916 that maintains a pressurized air space 820 separate from a water space 840. In the illustrated embodiment, return rams 904 can be connected to the lever arms 90 to regulate descent of the arms and urge the arms upwardly after a power stroke.

After passing the last lever arm 90 the container 50a is released, and a catch ram 918 is arranged to brake the falling container 50a, generating hydraulic pressure in the process. A director ram 920 can then urge the container 50a out of alignment with the tube 822, and the container 50a can begin its buoyant stroke.

In the illustrated embodiment, a water ballast tank 922 is separate from the water space 840, but a valve 924 selectively connects the spaces. During operation, if one of the knife valves v1-v4 is closed as a container 50a enters the water space 840, water from the water space 840 may be allowed to enter the ballast tank 922 via the valve 924 so as to equalize water volume. This or other ballast tanks may also be accessed in other embodiments to make up for volume issues throughout the water column 41.

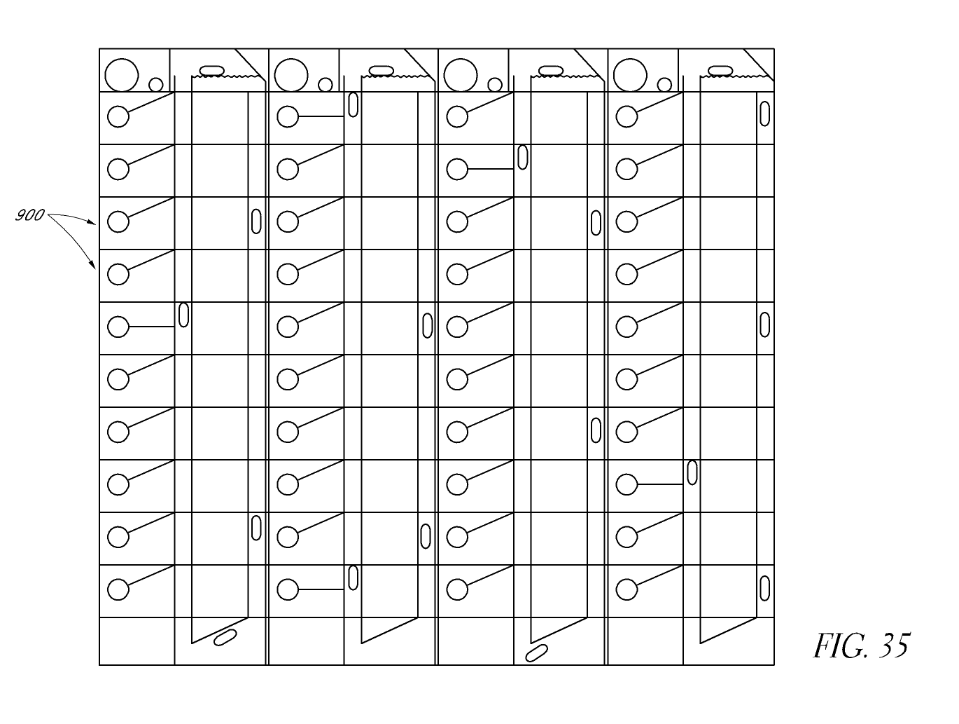

With reference next to FIG. 35, in still another embodiment a plurality of modules 900 can be joined together to make a power plant. As shown, the tubes 822 and chambers 44 of modules can be aligned in columns to make for a very long power stroke and buoyant stroke. In some embodiments the modules are separately built, and then joined together on-site. Notably, several columns and rows of modules 900 can be employed. In some embodiments each column operates independently of the other columns. In other embodiments the columns share at least some components such as hydraulic pressure, and may drive one or several communal electricity generators.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. For example, the gripper assembly discussed in connection the embodiments of FIG. 15 can also be used with the linear generator embodiments discussed in connection with FIG. 23, and the process for substantially concurrently transferring containers 50 between the first and second fluids can be used with the embodiments of FIGS. 24, 25, 26, or otherwise. Furthermore, the containers 50a of FIGS. 27A-B can be used with other embodiments, and the embodiments of FIGS. 28-35 share many components that be can be interchanged. Further the nice valves of FIG. 29 can be used in several other of the embodiments described herein. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. An electrical generator, comprising:
a hull having an entry area and an exit area and defining an air space, the entry area being disposed above the exit area, the air space in fluid communication with ambient air surrounding the hull;
a fluid column configured to substantially enclose a volume of water;
a weighted container having an adjustable buoyancy and a potential energy, the weighted container configured to fall through the air space by force of gravity, the weighted container thereby losing at least some of the potential energy; and
an electric power generation system, the electric power generation system configured to engage the weighted container as the weighted container falls through the air space to convert at least some of the lost potential energy into electricity;
wherein the entry area is configured to selectively allow the weighted container to enter the air space, and the exit area is configured to selectively eject the weighted container from the air space to the fluid column, and
wherein, when the weighted container is in the fluid column, the buoyancy of the weighted container is adjusted so that the weighted container floats in the water.

2. The generator of claim 1 in connection with a water tower configured to store water in an elevated reservoir and to distribute water under pressure from the reservoir to a surrounding community, wherein the fluid column communicates with the water tower reservoir.

3. The generator of claim 1, wherein the buoyancy of the weighted container is adjusted based on the vertical distance between the weighted container and entry area.

4. The generator of claim 1, wherein the entry area comprises a gripper assembly having a chamber and one or more grips, the chamber configured to receive the weighted container and the one or more grips configured to secure the weighted container in the gripper assembly.

5. The generator of claim 4, wherein the electric power generation system further comprises a guard including an actuator and defining a space.

6. The generator of claim 5, wherein the gripper assembly is configured to rotate into alignment with the guard, thereby allowing the weighted container to be transferred from the gripper assembly to the guard by releasing the one or more grips.

7. The generator of claim 1, wherein the fluid column further comprises a substantially horizontal lower portion and a substantially horizontal upper portion connected by a substantially vertical portion.

8. The generator of claim 7, wherein:
the generator further comprises a second weighted container;
one of the weighted container and the second weighted container is configured to move through the lower portion and the other of the weighted container and the second weighted container is configured to move through the upper portion; and
the weighted containers are configured to concurrently move through the upper portion and the lower portion in substantially opposite directions.

9. The generator of claim 1, wherein:
the generator further comprises a vertical support system, the vertical support system comprising a pulley and an elongate member connected with the electric power generation system; and
the vertical support system is configured to reduce the stress on the electric power generation system when the weighted container nears the end of its fall through the air space.

10. The generator of claim 9, wherein the vertical support system further comprises a brake, the brake configured to engage when the weighted container nears the end of its fall through the air space.

11. A method of generating electricity, the method comprising:
providing a hull, a fluid column, and a weighted container, wherein:
the hull defines an air space, the air space in fluid communication with ambient air surrounding the hull,
the fluid column is configured to substantially enclose a volume of water, and
the weighted container has an adjustable buoyancy and a potential energy, the weighted container being configured to fall through the air space by force of gravity, the container thereby losing at least some of the potential energy;
moving the weighted container into the air space;
engaging an electric power generation system with the weighted container as the weighted container falls through the air space to convert at least some of the lost potential energy into electricity;
ejecting the weighted container from the air space to the fluid column; and
adjusting the buoyancy of the weighted container when the weighted container is in the fluid column such that the weighted container is buoyant in the water.

12. The method of claim 11, further comprising:
opening a door to an entry chamber, the entry chamber adjacent the air space;
moving the weighted container into the entry chamber;
closing the door; and
removing substantially all of the water in the entry chamber.

13. The method of claim 11, further comprising:
loading the weighted container into a chamber of a gripper assembly;
closing at least one grip on a gripper assembly;
rotating the gripper assembly;
releasing the at least one grip; and
transferring the weighted container to the electric power generator by force of gravity.

14. A power generator, comprising:
a first container and a second container;
a fluid column having a substantially horizontal lower portion and a substantially horizontal upper portion connected by a substantially vertical portion, the fluid column enclosing a volume of a fluid having a density greater than air;
a hull comprising an entry portion and an exit portion with an air space therebetween, the entry portion configured to receive the first and second containers from the fluid column and to eject the first and second containers into the air space, the exit portion configured to receive the first and second containers from the air space and to eject the first and second containers into the fluid column;
a generation system located at least partly in the air space, the generation system configured to be energized by at least one of the first and second containers when at least one of the first and second containers are in the air space; and
wherein one of the first and second containers is configured to move through the lower portion and the other of the first and second containers is configured to move through the upper portion, the first and second containers configured to concurrently move through the upper portion and the lower portion in substantially opposite directions, thereby enhancing the balance of the generator.

15. The generator of claim 14, wherein the fluid in the fluid column is water.

16. The generator of claim 14, wherein each of the first and second containers are configured to intake an amount of fluid before being ejected into the air space, and are further configured to expel at least some of the amount of fluid after being ejected into the fluid column.

17. An electrical generator, comprising:
a hull defining an air space and a water space, the water space having a water column, and an interface being defined between the air and water space, the air space being kept at a pressure sufficient so that water does not flow through the interface;
a weighted container configured to fall through the air space by force of gravity and enter the water space through the interface; and
an electric power generation system configured to engage the weighted container as the weighted container falls through the air space so as to generate electric power.

18. An electrical generator as in claim 17 additionally comprising a plurality of valves configured to separate the water column into a plurality of columns that do not communicate head therebetween.
